(19) United States
(12) Patent Application Publication
(10) Pub. No.: US 2009/0252932 A1
(43) Pub. Date: Oct. 8, 2009

(54) ACTINIC ENERGY RAY CURABLE RESION COMPOSITION AND USE THEREOF

(75) Inventors: Takahiro Kitano, Ibaraki (JP); Hiroshi Matsugi, Gifu (JP); Takashi Imazu, Gifu (JP); Keiji Kubo, Ibaraki (JP); Masayasu Ogushi, Ibaraki (JP); Hirokazu Suzuki, Ibaraki (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kuraray Co., Ltd., Kurashiki-shi (JP)

(21) Appl. No.: 11/721,843

(22) PCT Filed: Dec. 15, 2005
(86) PCT No.: PCT/JP2005/023076

§ 371 Date: Jun. 15, 2007

(30) Foreign Application Priority Data
Dec. 15, 2004 (JP) 2004-363631
Mar. 28, 2005 (JP) 2005-093020

(51) Int. Cl. C08J 3/28; C08J 7/04; B29C 35/08; B32B 3/10; B32B 37/14

(52) U.S. Cl. 428/195.1; 522/148; 427/515; 264/494; 156/230

(57) ABSTRACT

An active energy ray-curable resin composition is handleable when it is formed into an uncured film. The resin composition cures quickly, is formable, and can be used to make a hard coat layer with a high hardness. Specifically, the active energy ray-curable resin composition of the present invention contains a vinyl polymer having alkoxysilyl groups in its side chain, along with a photoacid generator. In its uncured state, the active energy ray-curable resin composition has a glass transition temperature of 15° C. to 100° C. 90 mass % or more of the Si-containing compound or Si-containing compound unit present in the active energy ray-curable resin composition is represented by the following structural formula 1:

(R¹)ₙSi(OR²)₄₋ₙ (Structural formula 1)

wherein R¹ is a structural unit of the backbone of the vinyl polymer of the component (a), a residue bound to the backbone, a polymerizable group that can serve as the structural unit or the residues or a substituted or unsubstituted alkyl or aryl group; R² is an alkyl group having 1 to 5 carbon atoms; and n is an integer of 1 to 3.

### TECHNICAL FIELD

The present invention relates to an active energy ray-curable resin composition, a laminate having a layer of the active energy ray-curable resin composition, as well as a method for producing a cured laminate by irradiating the laminate with an active energy ray and a cured laminate produced by the method.

### BACKGROUND ART

Plastic materials have advantages over glass in that they are resistant to impact, can readily be formed into an articles having a curved surface, and are lightweight. However, plastic materials also have disadvantages: They are susceptible to scratches varying in size and depth and their appearances are likely to be affected by dust particles trapped within the scratches. Therefore, there is a great need to increase the scratch resistance of the surface of plastic shaped articles.

One approach is to simply provide plastic shaped articles which have a curved surface, with a hard coat property. In this approach, a laminate having a cured resin layer is shaped into an article. The cured resin layer is made of a thick soft layer and a thin hard layer. The article with such a construction acquires desired hard coat property (Patent Document 1). The laminate obtained by this technique, however has drawbacks in that it is not hard enough because of the thin hard layer and it can only be used in applications where it is not stretched much since the soft layer and the hard layer are each a cured layer. For example, the cured layer is likely to be cracked when the laminate is heated and stretched 25 times or more in area by deep drawing.

Different techniques have been proposed to circumvent these problems. One such technique involves laminating an active energy ray-curable resin composition onto a thermoplastic resin substrate, heat-shaping the laminate while it is still uncured, and irradiating the shaped laminate with an active energy ray to impart hard coat property (Patent-Document 2). Another technique involves making a transfer sheet having a transfer layer of an uncured active energy ray-curable resin composition, transferring the transfer layer onto a shaped article as it is shaped by injection molding, and irradiating the resulting shaped laminate with an active energy layer to form a hard coat layer (Patent Document 3).

A major component of the active energy ray-curable resin composition used in the technique of Patent Document 2 is a polymer that has radical-polymerizable unsaturated groups introduced in it. It is difficult to adjust the amount of the radical-polymerizable unsaturated group introduced in the polymer since the unsaturated group must be present in relatively small amounts in the polymer to ensure that the polymer remains a handleable solid, whereas it must be present in relatively large amounts to achieve sufficiently hard surfaces.

The techniques of Patent Documents No. 2 and No. 3 both use a compound containing radical-polymerizable unsaturated bonds However, compounds containing radical-polymerizable unsaturated bonds are generally unstable at high temperatures (for example, 150° C. or above) that are used to shape thermosetting resins: They set in a short time during heat-shaping. Therefore, when this compound is used to make a thin film (less than 1 mm thick), such a film can be shaped properly since shaping of thin films requires only a short time of heating. However, when it is used in a thick film (1 mm or more in thickness), the film may not be properly shaped into a shaped article since the longer heating causes the compound to set, making the cured layer susceptible to cracking. Thus, when the techniques proposed by Patent Documents No. 2 and No. 3 are used to make a laminated plate or a shaped article shaped by moderate bending of the laminated plate (for example, at an area stretch ratio of about 4 times), the appearance of the products is not significantly affected even if polymerization proceeds to some extent during the heating or shaping process. In contrast, when these techniques involve stretching of a laminated plate at a greater area stretch ratio (for example, 25 times or more), as in deep drawing, the appearance of the products can be significantly affected even by minor polymerization.

Furthermore, the polymerization involving radical-polymerizable unsaturated groups is prone to inhibition by oxygen. Thus, this type of polymerization can achieve only poor curability at the surface of the polymer products exposed to air, resulting in an insufficient hardness of the product.

Some compounds other than those having polymerizable unsaturated bonds can also form polymer products with hard surfaces. One example is silicone resins that cure when exposed to active energy rays (Patent Document 4). However, hydrolysable silane compounds or their hydrolysates used in these silicone resins can produce active silanol groups, which can undergo condensation to cause cracking in the shaped products. Thus, these silicone resins are not suitable for making deep drawn products.

In addition to the above-described techniques, techniques such as roll coating and dipping may also be used to impart hard coat property to plastic shaped articles having a curved surface. Specifically, these techniques are used to impart the hard coat property directly to resin plates. However, these techniques are each a batch process and thus cannot achieve high production efficiency. For this reason transfer techniques by which a functional film laminated onto a transfer sheet is directly transferred to a resin plate, are increasingly used in place of the foregoing techniques to impart hard coat property to resin plates. One such transfer technique uses an acrylic photocurable resin in the transfer layer of a hard coat transfer membrane for imparting hard coat property to a resin plate (Patent Documents No. 5 and No. 6) Although acrylic photocurable resins can cure in a short time and can thus achieve high productivity, their curing system involving radical polymerization of acryloyl groups is susceptible to inhibition by oxygen and is likely to result in a decreased curability at the surface of the polymer products. For this reason, the polymerization must be carried out in an anaerobic condition. Besides the desired hardness can only be achieved when the acrylic photocurable resin is used in a 10 μm or thicker film.

Silicone resins composed of an acrylic resin, such as the aforementioned acrylates, a silica sol and an organosilane are mainly used as a material for hard coat layers. Silicone thermosetting resins generally have higher hardness than radical-based resins and are thought to be preferred to radical-based resins for use in the transfer layer of a transfer membrane. In fact, hard coat transfer membrane using a silicone resin in the transfer layer have been proposed (Patent Document 7). However, the transfer layer requires an associated adhesive layer; forming the two or more layered structure results in a decreased productivity and an increased production cost. In addition, silicone resins as described in Patent Document 7 are generally thermosetting resins and take several minutes to several hours to cure. This further decreases the productivity.

One technique has been proposed that eliminates the foregoing problems by using an active energy ray-curable resin composition composed of an acrylic photocurable t resin and a silicone resin in the transfer layer (Patent Document 81. While this technique can achieve hard coating, increasing the hardness of the transfer layer following the irradiation with active energy ray requires heating or additional irradiation with active energy ray that must be carried out for a sufficiently long period of time. This increases the production cost. In addition, the low molecular weight acrylic monomer used in this technique makes the surface of the substrate considerably tacky. The tacky uncured substrate is difficult to wind on a roll, so that it is mostly produced as sheets, rather than as a roll. This makes it difficult to further improve the productivity.

These problems are addressed by the use of a resin composition comprising a condensate of an alkoxysilane-containing vinyl copolymer and a colloidal silica or an alkoxysilane, as described in Patent Documents No. 9 and No. 4. When the resin composition is applied to a film and the uncured film is stored after removal of the solvent by evaporation the condensation gradually proceed due to the active silanol groups present in the colloidal silica and water and acids used during the condensation of alkoxysilane. This makes it difficult to store the film.

In recent years the above-described laminates are used in liquid crystal panels to give the panels the necessary anti-reflection property one of the important features of liquid crystal panels and other display panels that are used under illumination of fluorescent light tubes. The anti-reflection property of display panels decreases the ratio of light reflected off the panel to light incident upon it, ensuring sharp image quality. Many display panels have an anti-reflection film on their surfaces to achieve anti-reflection property. An anti-reflection property is obtained by laminating two layers with different refractive indices a bottom high index layer and a top low index layer formed over the bottom layer. The light reflected by the high index layer and the light reflected by the low index layer interfere and cancel out each other because of the difference in the light path lengths. As a result the light reflected by the panel surface is decreased.

Traditionally anti-reflection films are formed over the surface of display panels or other substrates by applying an anti-reflection resin composition to the surface that requires anti-reflection coating. However, a new technique known as film transfer technique has recently attracted much attention. In this technique, an anti-reflection film is transferred to the surface of an article that requires anti-reflection treatment (or, the surface of display panels) by applying heat or pressure to the film. This technique improves the handleability of the products and reduces the production cost. One such technique for thermally transferring an anti-reflection film uses a transfer membrane that includes a transfer layer. The transfer layer is constituted of an anti-reflection layer, a hard coat layer and an adhesive layer. The anti-reflection layer has at least one layer having a low refraction index (Patent Documents No 10 and 11).

The technique described in Patent Documents No. 10 and 11 has a disadvantage in that the structure of the anti-reflection film tends to be complex since an additional intermediate layer needs to be disposed between the adhesive layer and the anti-reflection layer when the adhesion between the two layers is insufficient. Such an anti-reflection film is also costly. To address this problem, a transfer membrane has been proposed that has a two-layered structure that is constituted of an anti-reflection layer and a thermosetting adhesive layer. The thermosetting adhesive layer exhibits hard coat property when cured (Patent Document 12). Despite its two-layered structure, the transfer membrane may produce interference patterns as seen in an oil film when the refraction index of the adhesive layer is greater than that of the article to the surface of which the transfer membrane is transferred.

In a specific printing method, laminates that have a layer of an active energy ray-curable resin composition can be exposed to an active energy ray to form a resin pattern. Such a printing method is useful in making lenticular lens sheets that require accurate light-blocking patterns. There is a need to increase the accuracy of such patterning, as described below.

Several processes have been proposed for forming the light-blocking patterns of lenticular lens sheets. In one such process, a light-blocking coating is applied to the ridges or troughs of an uneven lenticular lens pattern (Patent Document 13). In another process, a light-blocking pattern formed on a printing roll is thermally laminated onto a lenticular lens sheet as the lens sheet is extruded (Patent Document 14).

However, the recent trend toward finer images has led to an increased demand for finer light-blocking patterns Specifically, the technique described in Patent Document 13 cannot achieve high printing accuracy because the uneven pattern has inevitably become smaller, as accompanied with pattern pitch being made finer. It is difficult by the technique described in Patent Document 14 to accurately align the lenticular lens pattern with the light-blocking pattern on a printing roll.

One technique that enables the formation of finer patterns than are achieved by the techniques of Patent Documents No. 13 and No. 14 is to take advantage of the stickiness of the unexposed areas of photosensitive resin. Specifically colorants are applied to the sticky unexposed areas to form a color pattern (Patent Documents No. 15 and 16).

In the techniques described in Patent Documents No. 15 and 16, however dust particles and fingerprints tend to stick to the surface of the laminate because of the strong stickiness that the unexposed areas at the surface of laminates have before application of the color layer For this reason both techniques are not suitable for the production of lenticular lens sheets and other optical elements. Furthermore, each of these techniques uses a radical-curable adhesive (such as one described In Patent Document 15) whose polymerization is susceptible to inhibition by oxygen. Such an adhesive will not easily cure in the atmosphere This poses a particularly significant problem when it is desired to form lenticular lenses with a finer lens pitch and the adhesive layer needs to be made correspondingly thinner.

By properly choosing the type of the photosensitive resin material, the stickiness that the unexposed areas at the surface of the laminate have before application of the color layer can be reduced, so that dust particles and fingerprints adhere to the surface of the laminate with difficulty. However, decreasing the stickiness of the unexposed areas results in insufficient adhesion of the colorants to the unexposed areas. This leads to partially defective color patterns, defective shapes and insufficient adhesion of color patterns. Thus, to make it difficult to allow dust particles and fingerprints to adhere to the surface of the laminate before application of the color layer and to ensure adhesion of the colorants to the unexposed areas are two contradictory requirements. It is difficult to fulfill the two requirements at the same time.

Patent Document 1: Japanese Patent Application Laid-Open No. Hei 4-93245
Patent Document 2: Japanese Patent Application Laid-Open No. Sho 61-72548
Patent Document 3: Japanese Patent Application Laid-Open No. Hei 4-201212

### Patent Document 4: Japanese Patent Application Laid-Open No 2002-22905

Patent Document 5: Japanese Patent Application Laid-Open No. Sho 62-62869
Patent Document 6: Japanese Patent Application Laid-Open No. Hei 7-314995
Patent Document 7: Japanese Patent Application Laid-Open No. Hei 8-1720
Patent Document 8: Japanese Patent Application T aid-Open No. Hei 1-266155

### Patent Document 9: Japanese Patent Application Laid-Open No 2000-109695

### Patent Document 10: Japanese Patent Application Laid-Open No Hei 10-16026

### Patent Document 11: Japanese Patent Appi-cation Laid-Open No Hei 11-288225

Patent Document 12: Japanese Patent Application Taid-Open No. Hei 8-248404
Patent Document 13: Japanese Patent Application Laid-Open No. Sho 56-38035
Patent Document 14: Japanese Patent Application Laid-Open No. Hei 9-120102
Patent Document 15: Japanese Patent Publication No. Hel 2-16497
Patent Document 16: Japanese Patent Application Laid-Open No. Sho 59-121033

### DISCLOSURE OF THE INVENTION

### Problems to be Solved by the Invention

The present invention addresses the above-described problems of the prior art. Accordingly, it is an object of the invention to provide an active energy ray-curable resin composition that is handleable when it is formed into an uncured film, can cure quickly and is formable, and can be used to make a hard coat layer with a high hardness. It is another object of the present invention to provide a laminate made of a substrate and a layer of the active energy ray-curable resin by laminating the composition on the substrate. It is still another object of the present invention to provide a method for producing a cured laminate by irradiating the layer of the active energy ray-curable resin of the laminate with an active energy ray. It is still another object of the present invention to provide a cured laminate obtained by the method.

### Means for Solving the Problems

The present inventors have found that the foregoing problems of the prior art can be solved by an active energy ray-curable resin composition that has a glass transition temperature of 15° to 100° C. in its uncured state and has a specific composition that cures as its alkoxysilane component undergoes condensation polymerization. This finding ultimately led to the present invention.

Specifically, the present invention provides an active energy ray-curable resin composition that cures primarily by the condensation of alkoxysilyl groups and that meets the following requirements (A), (B) and (C):

(A) the active energy ray-curable resin composition contains the following components la) and (b):
(a) a vinyl polymer having alkoxysilyl groups in its side chain and
b) a photoacid generator;

(B) in its uncured state, the active energy ray-curable resin composition has a glass transition temperature of 15° C. to 100° C.; and

(C) 90 mass % or more of the Si-containing compound or Si-containing compound unit present in the active energy ray-curable resin composition is re-resented by the following structural formula 1:

(R¹)ₙSi(OR²)₄₋ₙ (Structural formula 1)

wherein R¹ is a structural unit of the backbone of the vinyl polymer of the component (a), a residue bound to the backbone, a polymerizable group that can serve as the structural unit or the residue, or a substituted or unsubstituted alkyl or aryl group; R² is an alkyl group having 1 to 5 carbon atoms; and n is an integer of 1 to 3.

The present invention also provides a laminate comprising a substrate, and an active energy ray-curable resin layer formed of the above-described active energy ray-curable resin composition and laminated on the substrate. The laminate can serve as a postformable laminate by using a postformable substrate as the substrate. By using as the substrate a base film that may include a release layer, the active energy ray-curable resin layer can serve as a transfer layer and, thus, the laminate can be used as a transfer membrane.

The present invention also provides a method for producing a cured laminate comprising a cured resin layer formed on a substrate, comprising irradiating the active energy ray-curable resin layer of the above-described laminate, comprising a substrate, and an active energy ray-curable resin layer formed of the active energy ray-curable resin composition and laminated on the substrate with an active energy ray to cure the active energy ray-curable resin layer to form a cured resin layer. The present invention further provides a cured laminate obtained by the method. In one of alternative modes of the production method, when the above-described laminate (comprising a substrate, and an active energy ray-curable resin layer formed of the active energy ray-curable resin composition and laminated on the substrate) is the postformable laminate, the present invention provides a method for producing a cured laminate shaped article, as described below. When the above-described laminate is the transfer membrane, the present invention provides a method for producing a laminate-transferred article, as described below.

Specifically, the present invention provides a method for producing a cured laminate shaped article from the above-described laminate that is used as a postformable laminate, the method comprising the following steps (1) and (2) of:

(1) shaping the laminate that is used as a postformable laminate by heating it to a temperature at which the laminate can be shaped; and

(2) irradiating the active energy ray-curable resin layer of the shaped article obtained in the step (1) with an active energy ray to cure the active energy ray-curable resin layer to form a cured resin layer.

The present invention also provides a method for producing a laminate-transferred article from the above-described laminate that is used as a transfer membrane, the method comprising the following steps (I) and (II) of:

(I) transferring the transfer layer of the laminate that is used as a transfer membrane by bringing the transfer layer into contact with an article and subsequently peeling the base film; and

(II) irradiating the transfer layer transferred to the article obtained in the step (II with an active energy ray to cure the active energy ray-curable resin layer in the transfer layer to form a cured resin layer.

The present invention also provides a printing method comprising the following steps (i) through (iii) of:

(i) irradiating part of the active energy ray-curable resin layer of the above-described laminate comprising a substrate and an active energy ray-curable resin layer formed of the active energy ray-curable resin composition and laminated on the substrate, with an active energy ray to cure the active energy ray-curable resin layer only in the part irradiated with the active energy ray to thereby form a cured area and an uncured area in the active energy ray-curable resin layer;

(ii) laminating and pressing a patterning resin layer onto the active energy ray-curable resin layer of the laminate obtained in the step (i), the patterning resin layer being formed of a patterning resin composition comprising 50 mass 1 to 95 mass § of an inorganic filler mixed with a binder; and

(iii) removing the patterning resin layer from the cured area of the active energy ray-curable resin layer of the laminate obtained in the step (ii), leaving the patterning resin layer only in the uncured area, to form a resin pattern. The present invention also provides a printed article obtained by the printing method.

One specific embodiment of the above-described printing method of the present invention is as follows: In the step (i), the substrate of the laminate is flat on one side and contains a plurality of aligned convex lenses on the other side. The active energy ray-curable resin layer is laminated on the flat surface of the substrate to form the laminate, and then the laminate is irradiated from its convex lens surface side of the substrate with the active energy ray. In the step (ii), the patterning resin composition contains a colorant and the patterning resin layer forms a light-blocking pattern. The present invention also provides a printed article that is used as a lenticular lens sheet, which is obtained by the printing method in which the patterning resin composition contains a colorant and the patterning resin layer forms a light-blocking pattern. Another specific embodiment of the above-described printing method of the present invention includes the following step (iv) after the step (iii) of:

(iv) irradiating the entire surface of the active energy rav-curable resin layer with an active energy ray to cure the entire active energy ray-curable resin layer.

### Advantages of the Invention

According to the present invention, there is provided an active energy ray-curable resin composition that is handleable in its uncured state, can cure quickly and is formable, and can be used to make a laminate having a hard coat layer with a high hardness. The laminate may be laminated on a postformable substrate to make a formable laminate, or it may be laminated on a base film, which may include a release layer, to make a transfer membrane. The transfer layer of the transfer membrane is characterized in that it does not produce interference patterns as seen in an oil film when transferred to an article. The cured laminate obtained by irradiating the laminate with an active energy ray can be used as a screen protect-on panel.

According to the present invention, there is also provided a method for producing a cured laminate using the laminate, a method for producing a cured laminate shaped article using the formable laminate, and a method for producing a laminate-transferred article using the transfer membrane. In particular, the method for producing a cured laminate using the laminate provides a printing method, a printed article and a lenticular lens sheet obtained by the printing method. The printing method keeps the unexposed area of the photosensitive resin layer free of dust particles and fingerprints when the unexposed area is exposed to the atmosphere. The printing method can form a resin pattern on the unexposed area with good adhesion. The resin pattern formed by the printing method can readily cure in the atmosphere and is sufficiently fine.

### BRIEF DESCRIPTION OF THE DRAWINGS

FIGS. 1(a), 1(b), 1(c), 1(C′), 1(d), 1(d′) and 1(e) illustrate the steps involved in a printing method of the present invention.

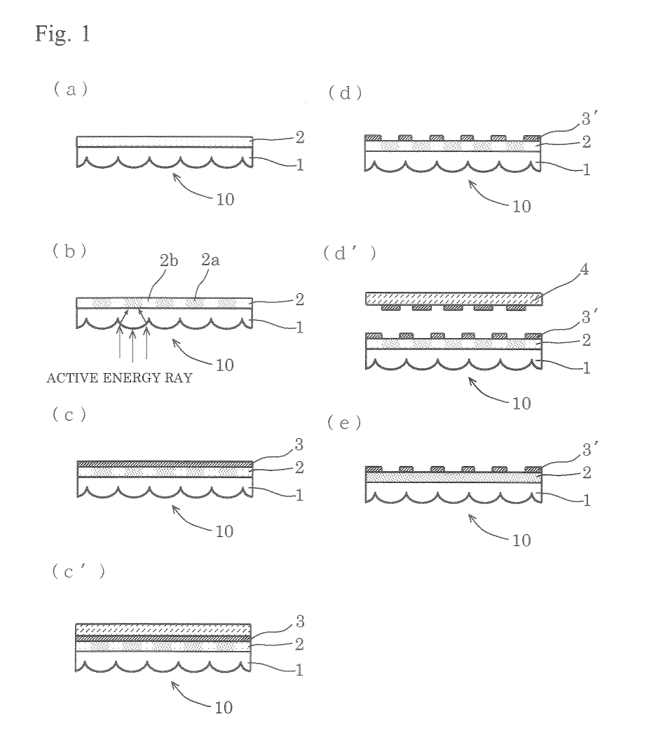

### REFERENCE NUMERALS

1. Substrate
2. Active energy ray-curable resin layer
2a Cured area
2b. Uncured area
3. Patterning resin layer
3′. Resin pattern
4 Base film
10. Laminate

### BEST MODE FOR CARRYING OUT THE INVENTION

First, the active energy ray-curable resin composition of the present invention is described.

The active energy ray-curable resin composition of the present invention is a composition that cures primarily by the condensation of alkoxysilyl groups. What is meant by “cures primarily by the condensation of alkoxysilyl groups” is that the majority of the functional groups involved in the curing of the composition are alkoxyshlyl groups. The active energy ray-curable resin composition that cures in this manner is used because alkoxysilyl groups form Si—O—Si bonds that make the resulting film very hard. In addition, alkoxysilyl groups have sufficient heat-resistance to withstand high temperatures at which the composition is shaped. While a wide range of active energy rays can be used in the present invention, including ultraviolet rays, visible light, laser lights, electron beams and x-rays, ultraviolet rays are most practical. Specific examples of the sources of ultraviolet rays include low-pressure mercury lamps, high-pressure mercury lamps, xenon lamps and metal halide lamps.

The active energy ray-curable resin composition for use in the present invention must meet the above-described requirements (A), (B) and (C). Each requirement will now be described below.

The requirement (A) is intended to allow the active energy ray-curable resin composition to cure primarily by the condensation of alkoxysilyl groups and to ensure the stability of the composition upon shaping. Specifically, the requirement (A) is that the active energy ray-curable resin composition contains a vinyl polymer having alkoxysilyl groups in its side chain (Component (a)) and a photoacid generator (Component (b)).

While the vinyl polymer (Component (a)) may be any vinyl polymer that contains one or more alkoxysilyl groups, it preferably holds that, given that the number of monomer units in one molecule of the polymer is a (mol) and the number of alkoxysilyl groups in one molecule of the polymer is b (mol), b/a is from 0.05 to 0399. When the value of b/a is less than 0.05, cured products of the active energy ray-curable resin composition may have insufficient hardness. When the value of b/a is greater than 0.99 the requirement (B) may not be met: The composition in its uncured state becomes difficult to handle.

The alkoxysilyl group is a functional group represented by the structural formula 2 below. The alkoxysilyl groups in the vinyl polymer (Component (a)) may bind to the backbone of the vinyl polymer (Component (a)) either directly by silicon atoms in the structure formula 2 or indirectly via a specific residue that binds to the backbone of the vinyl polymer, as mentioned later One example of silicon atoms in the structural formula 2 directly binding to the backbone of the vinyl polymer (Component (a)) is seen in the polymerization of alkoxysilyl ethylene.

—Si(R³)ₘ(OR⁴)₃₋ₘ (Structural formula 2)

in the structural formula 2, R³ is a residue that can bind to the backbone of the vinyl polymer (Component (a)) or a polymerizable group or a substituted or unsubstituted alkyl or aryl group that can function as the residue R⁴ is an alkyl group having 1 to 5 carbon atoms. m is an integer of 0 to 2. When it is desired to give a harder cured product, m is preferably 0.

When R³ is a polymerizable group that can function as the residue that binds to the backbone of the vinyl polymer (Component (a)), examples of R³ include (meth)acryloyloxyalkyl groups, such as (meth)acryloyloxypropyl group, (meth)acryloyloxyethyl group and (meth)acryloyloxlymethyl group, vinyl group and styryl group. These functional groups may also form the backbone of the vinyl polymer (Component (a)), serving as structural units of the backbone.

When R³ is a substituted or unsubstituted alkyl or aryl group examples of R³ include alkyl groups such as methyl group, ethyl group, propyl group, butyl group, pentyl group, hexyl group, heptyl group and octyl group, and aryl groups, such as phenyl group and tolyl group.

Examples of the alkyl groups having 1 to 5 carbon atoms to serve as R⁴ include methyl group, ethyl group, propyl group, isopropyl group, butyl group, isobutyl group, t-butyl group, pentyl group and neopentyl group. Of these, methyl group is particularly preferred because the reactivity of these groups increases as their steric hindrance decreases.

Thus, the vinyl polymer having alkoxysilyl groups in its side chain (Component (a)) includes polymers obtained by homopolymerization of alkoxysilyl-containing vinyl monomers, polymers obtained by copolymerization, such as radical copolymerization, of alkoxysilyl-containing vinyl monomers and alkoxysilyl-free monomers and polymers obtained by reaction of vinyl polymers having functional groups at their terminals or in their side chains with compounds having alkoxysilyl groups and other functional groups.

Examples of the alkoxysilyl-containing monomers include (meth)acryloyloxy-containing alkoxysilanes, such as (meth)acryloyloxypropyltrimethoxysilane, (meth)acryloyloxypropyltriethoxysilane, (meth)acryloyloxypropylmethyldimethoxysilane, (meth)acryloyloxypropyldimethylmethoxysilane, di((meth)acryloyloxypropyl)dimethoxysilane and tri((meth)acryoyloxypropyl)methoxysilane, and vinyl-containing alkoxysilanes, such as vinyltrimethoxysilane vinyltriethoxysilane, divinyldimethoxysilane and vinylmethyldimethoxysilane. Of these, (meth)acryloyloxy-containing monomers, such as (meth)acryloyloxyalkyltrialkoxysilanes, are particularly preferred because polymers can be easily obtained from these monomers. Thus, a particularly preferred example of the vinyl monomers having alkoxysilyl groups in their side chain of Component (a) is alkoxysilyl-containing (meth)acrylic ester polymers. These alkoxysilyl-containing monomers may be used either individually in homopolymerization or in combinations of two or more in copolymerization.

While the monomer that can be copolymerized with the alkoxysilyl-containing monomers may be any monomer that does not have alkoxysilyl groups and that has polymerizable ethylenic unsaturated bonds, photopolymerizable ethylenic unsaturated compounds that have at least one ethylenic double bond in their molecules are generally preferred. Examples of such monomers include (meth)acrylic acid; monofunctional(meth)acrylate monomers, such as methyl(meth)acrylate, ethyl(meth)acrylate, propyl(meth)acrylate, n-butyl(meth)acrylate, t-butyl(meth)acrylate, 2-ethylhexyl (meth)acrylate, n-nonyl(meth)acrylate, cyclohexyl(meth)acrylate, benzyl(meth)acrylate, dicyclopentenyl(meth)acrylate, 2-dicyclopentenoxyethyl(meth)acrylate, glycidyl(meth)acrylate, methoxyethyl(meth)acrylate, ethoxyethyl(meth)acrylate, butoxyethyl(math)acrylate, methoxyethoxyethyl(meth)acrylate, ethoxyethoxyethyl(meth)acrylate, tetrahydrofurfuryl(meth)acrylate, 2-hydroxyethyl(meth)acrylate, 2-hydroxypropyl(meth)acrylate, 4-hydroxybutyl(meth)acrylate, phenoxyethyl(meth)acrylate, phenoxyethoxyethyl(meth)acrylate, biphenoxyethyl(meth)acrylate, biphenoxyethoxyethyl(meth)acrylate, norbornyl(meth)acrylate, phenylepoxy(meth)acrylate, (meth)acryloylmorpholine, N-[2-(meth)acryloylethyl]-1,2-cyclohexanedicarboimide, N-[2-(meth)acryloylethyl]-1,2-cyclohexanedicarboimide-1-ene, N-[2-(meth acryloylethyl]-1,2-cyclohexanedicarboimide-4-ene and polyalkyleneglycol mono(meth)acrylate; N-vinyl monomers, such as N-vinylpyrrolidone, N-vinylimidazole and N-vinylcaprolactam; styrene monomers, such as styrene, α-methylstyrene, methoxystyrene, hydroxystyrene, chloromethylstyrene and vinyltoluene; vinyl ether monomers, such as methyl vinyl ether, ethyl vinyl ether, butyl vinyl ether, hydroxyethyl vinyl ether, hydroxybutyl vinyl ether and nonafluorobutylethyl vinyl ether; vinyl ester monomers, such as allyl acetate, vinyl acetate, vinyl propionate, vinyl laurate and vinyl benzoate; and halogenated olefin monomers, such as vinylidene fluoride, tetrafluoroethylene, hexafluoropropene and vinylidene chloride These copolymer components may be used either individually or in combination of two or more.

Of these monomer that can be copolymerized with the alkoxysilyl-containing monomers, those that can form homopolymers having a relatively high glass transition temperature, in particular (meth)acrylate esters, are preferred since homopolymers of these monomers can be formed into a elongate tape that can be effectively wound on a roll during the roll-to-roll production of laminates from the active energy ray-curable resin composition of the present invention. Of different (meth)acrylate esters, methyl methacrylate is particularly preferred.

The vinyl polymer having alkoxysilyl groups in its side chains (Component (a)) may be one obtained by known techniques for introducing functional groups that involve the reaction of a vinyl polymer having functional groups at its terminals or in its side chains with a compound having alkoxysilyl groups and other functional groups. Examples of such reactions between functional groups include a reaction between vinyl groups and hydrosilyl groups, a reaction between isocyanate groups and hydroxyl groups, a reaction between isocyanate groups and amino groups, a reaction between epoxy groups and thiol groups, a reaction between epoxy groups and amino groups and a reaction between carboxyl groups and hydroxyl groups. These functional groups may be present either on the vinyl polymer or on the alkoxysilyl-containing compound. For example, with respect to reaction of Isocyanate groups with amino groups, a vinyl polymer having isocyanate groups may be reacted with a compound having amino groups and alkoxysilyl groups or a vinyl polymer having amino groups may be reacted with a compound having isocyanate groups and alkoxysilyl groups. One example of the vinyl polymer having isocyanate groups is a copolymer containing 2-methacryloyloxyethyl isocyanate as monomer units. One example of the compound having amino groups and alkoxysilyl groups is γ-aminopropyltrimethoxysilane. One example of the compound having isocyanate groups and alkoxysilyl groups is γ-isocyanatepropyltrimethoxysilane.

While the vinyl polymer having alkoxysilyl groups in its side chains (Component (a)) may be any of random copolymer, block copolymer and graft copolymer, random copolymers are particularly preferred because of their availability.

While the vinyl polymer (Component (a)) may have any weight average molecular weight as long as the requirement (B) “uncured resin composition has a glass transition temperature of 15° C. to 100° C.” is met, it preferably has an weight average molecular weight of 10,000 to 500,000, more preferably 30,000 to 300,000, to ensure handleabillty of the uncured resin composition and balanced ability of the resin composition to follow the substrate upon shaping. The weight average molecular weight of the alkoxysilyl-containing polymer can be determined by gel permeation chromatography (CPC) using polystyrene standards.

The vinyl polymer having alkoxysilyl groups in its side chains is present in the active energy ray-curable resin composition preferably in an amount of 30 mass % to 99.9 mass % and more preferably in an amount of 50 mass 1 to 99.5 mass % (by solid content without diluents) since too little of the vinyl polymer makes it difficult to achieve the hardness and the handleability of uncured composition in a well-balanced manner, whereas too much of it decreases the relative amount of the photoacid generator and, thus, decreases the curability of the composition.

The photoacid generator (Component (b)), another essential component of the active energy ray-curable resin composition of the present invention, decomposes upon exposure to active energy rays to generate an acid that acts on the alkoxysilyl groups to cause the resin composition to cure. The resulting acid facilitates the condensation of the alkoxysilyl group of the vinyl polymer (Component (a)). Examples of the photoacid generator include onium salts and sulfonic acid derivatives.

Cations of onium salts are onium ions. Examples include onium ions comprising S, Se, Te, P, As, Sb, Bi, O, I, Br, Cl or N≡N. Examples of anions include tetrafluoroborate (BF₄⁻) hexafluorophosphate (PF₆⁻) hexafluoroantimonate (SbF₆⁻) hexafluoroarsenate (AsF₆⁻) hexachloroantimonate (SbCl₆⁻), tetraphenylborate tetrakis(trifluoromethylphenyl)borate, tetrakis(pentafluoromethylphenyl)borate, perchloric acid ion (ClO₄⁻), trifluoromethanesulfonic acid ion ICF₃SO₃⁻), fluorosulfonic acid ion (FSO₃⁻) toluenesulfonic acid ion trinitrobenzensulfonic acid anion and trinitrotoluenesulfonic acid anion. While the onium salt may be any combination of the cations and the anions, combinations of sulfonium cations and phosphonium anions are less toxic and ensure fast curing and are thus preferred.

Examples of the sulfonic acid derivatives include sulfonates, such as disulfones, disulfonyldiazomethanes disulfonylmethanes, sulfonylbenzoylmethanes, imidesulfonates, benzoinsulfonates and 1-oxy-2-hydroxy-3-propylalcohol, pyrogalloltrisulfonates and benzylsulfonates. Specific examples include diphenyldisulfone, ditosyldisulfone, bis(phenylsulfonyl)diazomethane bis(chlorophenylsulfonyl) diazomethane, bis(xylylsulfonyl)diazomethane, phenylsulfonylbenzoyldiazomethane, bis(cyclohexylsulfonyl)diazomethane, bis(t-butylsulfonyl)diazomethane, 1,8-naphthalenedicarboxylic acid imide methylsulfonate, 1,8-naphthalenedicarboxylic acid imide tosylsulfonate, 1,8-naphthalenedicarboxylic acid imide trifluoromethylsulfonate, 1,8-naphthalenedicarboxylic acid imide camphorsulfonate, succinimide phenylsulfonate, succinimide tosylsulfonate, succinimide trifluoromethylsulfonate, succinimide camphorsulfonate, phthalinmide trifluorosulfonate, cis-5-norbornene-endo-2,3-dicarboxylic acid imide trifluoromethylsulfonate, benzoin tosylate, 1,2-diphenyl-2-hydroxypropyl tosylate, 1,2-di(4-methylmercaptophenyl) 2-hydroxypropyl tosylate, pyrogallol methylsulfonate pyrogallol ethylsulfonate, 2,6-dinitrophenylmethyl tosylate, o-nitrophenylmethyl tosylate and p-nitrophenyl tosylate.

The amount of the photo acid generator (Component (b)) in the active energy ray-curable resin composition is preferably 0.1 mass % to 15 mass %, more preferably 0.5 mass 1 to 5 mass % (by solid content without diluents). Too little of the photo acid generator impedes the curing process, whereas too much of it affects the physical properties of cured products.

In addition to Component (a) and Component (b), as specified by the requirement (A), the active energy ray-curable resin composition of the present invention may further contain a surfactant containing hydrocarbon groups having 8 to 30 carbon atoms as Component (C). Component (C) is added to the active energy ray-curable resin composition for the following reasons.

Hard coated resin plates in many cases require antistatic properties to prevent adhesion of dust particles and other contaminants. Tn order to provide shaped resin products with antistatic properties surfactants are widely added to resin compositions to form resin products. When the resin composition containing a surfactant is applied to the surface of a substrate, the surfactant is predominantly present on the side of the substrate exposed to air, making the surface antistatic. Likewise, when such a composition is used in the transfer layer of a transfer membrane, the surfactant is predominantly present on the side of the transfer layer exposed to air. Thus, when the transfer layer is transferred to the surface of an article, the surfactant is predominantly present at the interface between the article and the transfer layer. Since the surfactant is no longer predominantly present on the surface of the transfer layer exposed to air, the desired antistatic properties cannot be achieved on that surface. The addition of the surfactant having 8 to 30 carbon atoms (Component (c)) to serve as an antistatic to the active energy ray-curable resin composition containing Components (a) and (b) increases the relative affinity between the substrate and the surfactant. As a result, the surfactant (Component (c)) tends to be present on the side of the transfer membrane facing the substrate. When such a transfer layer is transferred to the surface of an article, the surfactant is predominantly present on the surface of the transfer layer exposed to air, providing the surface with desired antistatic properties. However, surfactants with the hydrocarbon groups having less than 8 carbon atoms are not likely to be present on the side of the transfer membrane facing the substrate. Surfactants with the hydrocarbon groups having more than 30 carbon atoms have an insufficient compatibility. The hydrocarbon groups of the surfactants are preferably straight-chained rather than branched, to improve the compatibility with the resin composition.

The surfactant (Component (c)) may be any known surfactant that has 8 to 30 carbon atoms, preferably 8 to 20 carbon atoms. Examples include anionic surfactants, such as sulfates (salts), sulfonates, phosphates, sulfosuccinates, carboxylic acids and sulfates (esters); cationic surfactants, such as quaternary cations, amine oxides, pyridinium salts and amine salts; nonionic surfactants, such as alkyl ethers, alkyl phenols, esters, ether esters, monool polyethers and amides; and amphoteric surfactants, such as betain, ether amine oxides, glycine and alanine. Of these, anionic surfactants are particularly preferred. Of different anionic surfactants, sulfosuccinates are particularly preferred.

Examples of the hydrocarbon group having 8 to 30 carbon atoms include dodecyl group and oleyl group.

Examples of sulfosuccinate surfactants include lithium salts, sodium salts and ammonium salts of monoalkylsulfosuccinates or dialkylsulfosuccinates. Of these, sodium salts of monoalkylsulfosuccinates are particularly preferred.

The hydrocarbon groups of the surfactant (Component (c)) may contain unsaturated bonds so that the surfactant can undergo radical polymerization.

The amount of the surfactant (component (c), in the active energy ray-curable resin composition is preferably 0.01 mass % to 10 mass % and more preferably 0.1 mass % to 5 mass % (by solid content of active energy ray-curable resin composition without diluents) Too little of the surfactant results in a decreased antistatic property-whereas too much of it may cause the resin composition to separate into phases.

The active energy ray-curable resin composition may contain a diluent to facilitate application of the resin composition as a thin film. The amount of the diluent may be adjusted depending on factors such as the desired thickness of resin film. The diluent may be any diluent commonly used in resin coatings, including ketones, such as acetone, methyl ethyl ketone, methyl isobutyl ketone and cyclohexanone; esters such as methyl acetate, ethyl acetate, butyl acetate, ethyl lactate and methoxyethyl acetate; ethers, such as diethyl ether ethylene glycol dimethyl ether, ethyl cellosolve, butyl cellosolve, phenyl cellosolve and dioxane; aromatic compounds, such as toluene and xylene; aliphatic compounds, such as pentane and hexane; halogenated hydrocarbons, such as methylene chloride, chlorobenzene and chloroform; and alcohols, such as methanol, ethanol, n-propanol and isopropanol. For example, when it is desired to form an approximately 3 μm-thick layer of the curable resin, 20 mass % of the solid resin composition is diluted with 80 mass % of the diluent and the mixture is applied to a wet thickness of 15 μm.

The requirement (B) for the active energy ray-curable resin composition of the present invention is intended to prevent adhesion of dust particles and fingerprints to the film of the active energy ray-curable resin composition formed primarily by the condensation of alkoxysilyl groups and to improve the windability of the film. Specifically, the requirement (B) is that in its uncured state, the active energy ray-curable resin composition has a glass transition temperature of 15° C. to 100° C. and preferably a glass transition temperature of 15° C. to 50° C. When the glass transition temperature of uncured active energy ray-curable resin composition is lower than 15° C., a film made of such a composition tends to become sticky and pick up dust particles. Such a film cannot easily be wound on a roll. Conversely when the glass transition temperature is higher than 100° C., the resin composition may not follow the substrate upon shaping and may come off the substrate after shaping. The glass transition temperature of uncured active energy ray-curable resin composition is determined by differential scanning calorimetry (DSC) of the solid content of uncured active energy ray-curable resin composition. When the uncured active energy ray-curable resin composition has two or more glass transition temperatures, it is the temperature that shows the greatest heat change.

The windability of active energy ray-curable resin composition in its uncured state is determined by a rolling ball tack test (JIS Z0237) Specifically, a laminate coated with a 3 μm-thick film of uncured resin composition is placed on a sloped surface and balls of different sizes are rolled on the slope. The uncured resin composition is determined to have an acceptable windability when the size of the largest ball that holds still on the slope is No. 2 or less. The angle of the slope used in the rolling ball tack test (JIS Z0237) is 30 degrees. When the size of the largest ball that holds still on the slope in the rolling ball tack test (JIS Z0237) is greater than No. 2, the uncured laminate is too tacky to ensure sufficient handleability.

The requirement (C) for the active energy ray-curable resin composition of the present invention is that 90 mass % or more, preferably 95 mass % or more of the vinyl polymer (Compound (a)) and other Si-containing compounds or Si-containing compound units present in the active energy ray-curable resin composition is represented by the structure formula 1 shown below. The active energy ray-curable resin composition must meet the requirement (C) because functional groups such as hydrosilyl group, silanol group and chlorosilyl group cannot be used in the active energy ray-curable resin composition since they are unstable in the air and will undergo condensation during the production of transfer membrane or during the storage of laminates. Partial hydrolysales of alkoxysilyl groups cannot be used in the present invention for the same reason. Thus, the requirement (C) must be met in order to ensure heat resistance and surface hardness of the resin composition during shaping,

(R¹)ₙSi(OR²)₄₋ₙ (Structural formula 1)

In the structural formula 1, R¹ is a structural unit of the backbone of the vinyl polymer (Component (a)), a residue bound to the backbone, a polymerizable group that can serve as the structural unit and/or the residue, or a substituted or unsubstituted alkyl or aryl group. R² is an alkyl group having 1 to 5 carbon atoms. n is an integer of 1 to 3. When R¹ is a polymerizable group that can serve as the structural unit of the backbone of the vinyl polymer (Component (a)) and/or the residue bound to the backbone, examples of such a polymerizable group include (meth)acryloyloxyalkyl groups, such as (meth)acryloyloxypropyl group (meth)acryloyloxyethyl group and (meth)acryloyloxymethyl group, vinyl group and styryl group. When R¹ is a structural unit of the backbone of the vinyl polymer (Component (a)) and/or a residue bound to the backbone, examples of such a structural unit or a residue include structural units of a backbone formed by the polymerization of the above-describe polymerizable groups through carbon-carbon double bonds, and/or atomic groups that exist between the backbone and the silicon atom. When the polymerizable group is (meth)acryloyloxypropyl group, the structural unit of the vinyl polymer backbone is a structural unit that comes from (meth)acryloyloxypropyl group and the group of atoms present between the backbone and the silicon atom is —COOCH₂CH₂CH₂—When the polymerizable group is (meth)acryloyloxyethyl group, the structural unit of the vinyl polymer backbone is a structural unit that comes from (meth)acryloyloxyethyl group and the group of atoms present between the backbone and the silicon atom is —COOCH₂CH₂—. When the polymerizable group is (meth)acryloyloxymethyl group, the structural unit of the vinyl polymer backbone is a structural unit that comes from (meth)acryloyloxymethyl group and the group of atoms present between the backbone and the silicon atom is —COOCH₂—. When the polymerizable group is vinyl group, the structural unit of the vinyl polymer backbone is a structural unit that comes from vinyl group and no group of atoms is present between the backbone and the silicon atom.

While it is highly preferred for the purpose of ensuring the handleability of uncured resin composition that the compound of the structural formula 1 be entirely formed of the vinyl polymer having alkoxysilyl groups in its side chains (Component (a), the compound may contain other low-molecular-weight silane compounds in amounts that do not affect the advantages of the present invention. Examples of the silane compounds include alkyl trialkoxysilanes and (meth) acryloyloxyalkyl trialkoxysilanes for n=1, and dialkyl dialkoxysilanes for n=2.

The low-molecular-weight silane compound represented by the structural formula 1 is present in the active energy ray-curable resin composition preferably in an amount of 10 mass 6 or less and more preferably in an amount of 5 mass % or less (by solid content without diluents). Too much of the silane compound results in a decrease in the handleability of the resin composition in its uncured state.

When necessary, the active energy ray-curable resin composition of the present invention may further contain vinyl ether compounds, epoxy compounds, oxetane compounds and other compounds that can undergo photopolymerization. Examples of the vinyl ether compound include ethylene oxide-modified bisphenol-A-divinyl ether, ethylene oxide-modified bisphenol-F-divinyl ether, ethylene oxide-modified catechol divinyl ether, ethylene oxide-modified resorcinol divinyl ether, ethylene oxide-modified hydroquinone divinyl ether and ethylene oxide-modified-1,3,5-benzenetriol trivinyl ether. Examples of the epoxy compound include 1,2-epoxycyclohexane, 1,4-butanediol diglycidyl ether, 3,4-epoxycyclohexylmethyl-3′,4′-epoxycyclohexane carboxylate, trimethylolpropane diglycidyl ether, bis(3,4-epoxy-6-methylcyclohexylmethyl)adipate, glycidyl ether of phenol novalac and bisphenol A diglycidyl ether. Examples of the oxetane compound include 3-ethyl-3-hydroxymethyloxetane, 3-ethyl-3-(phenoxymethyl)oxetane, di[1-ethyl(3-oxetanyl)]methylether and 3-ethyl-3-(2-ethylhexyloxymethyl)oxetane.

The amount of these photopolymerizable vinyl ether compounds, epoxy compounds or oxetane compounds in the active energy ray-curable resin composition is preferably 20 mass % or less and more preferably 5 mass % or less (by solid content without diluents).

The active energy ray-curable resin composition preferably meets the following requirement (D): It has an optically uniform refractive index in the visible range. The term “visible range” as used herein refers to light having a wavelength ranging from 400 nm to 700 nm. The term “optically uniform” as used herein means that light does not scatter within the resin composition. Specifically, the term means that the cured product of the resin composition has a haze value of 1% or less, preferably 0.3% or less. The active energy ray-curable resin composition that meets the requirement (D) can be used to make a dimming layer that has a high transmittance to light.

The resin composition may contain particles having a different refractive index from the matrix of the resin composition When the size of such particles is approximately 0.1 times the wavelength of incident light, the particles tend to scatter light. Thus, the particles, if any, have a size of preferably 40 nm or less, and more preferably 20 nm or less.

The active energy ray-curable resin composition in its cured state preferably meets the following requirement (E): The refractive index of the cured resin composition is in the range of 1.40 to 1.51. This requirement is intended to prevent occurrence of interference patterns as seen in an oil film that appear when the transfer layer of the transfer membrane formed of the active energy ray-curable resin composition of the present invention is transferred to the surface of an article. Such interference patterns are one of the factors that affect the appearance of the shaped products and appear when the article having the transfer layer transferred to it has a smaller refractive index than the adhesive layer and the adhesive layer has uneven thickness.

The problem of oil-like interference patterns can be eliminated by using an adhesive layer that has a refractive index equal to or lower than the article. Among materials commonly used in articles to which to transfer the transfer membrane are acrylic resins, PET, polycarbonate, polystyrene and styrene-acryl copolymers.

Polymethyl methacrylate, an acryl resin, has a particularly low refractive index of about 1.495 and is widely used. In theory, the oil-like interference patterns can be avoided in most substrates currently in use when the adhesive layer in its cured state has 1.495 or lower refractive index. In practice, however, visually noticeable interference patterns do not appear when the refractive index of the adhesive layer in its cured state is higher than that of the substrate by about 0.01. Thus, the oil-like interference patterns can be avoided in most substrates currently in use when the adhesive layer in its cured state has 1.51 or lower refractive index.

On the other hand, it is difficult to find materials that meet the requirements (A) and (B) at the same time when the refractive index of the cured adhesive layer is lower than 1.40. For this reason, the adhesive layer in its cured state must have a refractive index of 140 to 1.51. It preferably has a refractive index of 1.47 to 1.50 to ensure availability of materials.

When necessary, the active energy ray-curable resin composition may further contain, in amounts that do not affect the advantages of the present invention an inorganic filler, a polymerization inhibitor, a pigment, a dyes a defoaming agent, a leveling agent, a disperser, a light-diffusing agent, a plasticizer, an antistatic a surfactant, a non-reactive polymer, a near-infrared absorbing agent and other additives.

The active energy ray-curable resin composition described above can be prepared by uniformly mixing the component (a) and the component (b), and optionally the component (c) and other additives, in such a manner that the requirements (A) through (C) and, optionally, the requirement (D) are met. The components can be mixed using common techniques. When polymers are used, they may not necessarily be used in their isolated forms, but rather as polymer solutions obtained by solution polymerization.

The active energy ray-curable resin composition of the present invention is suitable for use as a material to make the active energy ray-curable resin layer in the laminate having the active energy ray-curable resin layer deposited on a substrate. Such a laminate can be manufactured by laminating the active energy ray-curable resin composition onto the substrate by common techniques. The resulting laminate is handleable in its uncured state, can cure quickly is highly shapeable, and can be used to make a hard coat layer having high hardness. Such a laminate is also encompassed by the present invention. The substrate may be properly selected depending on the intended purpose of the laminate and may be a metal substrate made of metals such as aluminum substrate and copper substrate, an alloy substrate, a resin substrate made of thermoplastic resin, thermosetting resin or active energy ray-curable resin, a ceramic substrate made of ceramics such as glass and alumina, or a composite substrate thereof. The laminate of the present invention finds various applications. For example, it may be used as a postformable laminate when the substrate is a postformable substrate. Alternatively, it may be used as a transfer membrane when the substrate is a base film. In such a case, the active energy ray-curable resin layer of the laminate serves as a transfer layer. The base film may include a release layer. These applications will be described later.

The active energy ray-curable resin composition of the present invention is suitable for use in formable laminates that can be used in different resin shaping processes including molding processes. The formable laminate has a postformable substrate and the active energy ray-curable resin layer laminated onto the postformable substrate. The active energy ray-curable resin layer is formed of the active energy ray-curable resin composition of the present invention. Such a formable laminate is also encompassed by the present invention. The formable laminate can be manufactured by depositing a film of the active energy ray-curable resin composition over the postformable laminate by using techniques such as impregnation, roll coating (as used in letterpress printing, lithographic printing, intaglio printing and other printing processes), spraying, curtain flow coating and transferring.

The postformable substrate may be a plate or a film of acrylic resins, PET, polycarbonate, polystyrene, styrene-acrylic copolymers, vinyl chloride resins, polyolefin and ABS (acrylonitrile-butadiene-styrene) copolymers, a plastic substrate formed of polyethylene and polypropylene, or a substrate formed of thermosetting resins. The postformable substrate may have any desired thickness: It preferably has a thickness of 0.1 mm to 50 mm.

When the active energy ray-curable resin composition to make the formable laminate contains a diluent (solvent), the diluent is preferably removed after the composition has been formed into a film. The diluent is typically removed by heating the film to evaporate the diluent. The heating may be carried out by using a heat oven, a far-infrared oven or an ultra far-infrared oven.

The formable laminate of the present invention may include a functional layer including the curable resin layer of the present invention. The surface of the substrate may be made hydrophilic prior to the deposition of the functional layer. Such a functional layer may have the curable resin layer of the present invent on a color layer and an antimicrobial layer.

Depending on its intended purpose, the formable laminate of the present invention may include layers other than those described above, including decorative layers, such as print layers and color layers, vapor-deposited layers (conductive layers) made of metals or metal compounds, and primer layers. The formable laminate may have any of the following layered structures: curable resin layer curable resin layer/primer layer, print layer/curable resin layer, decorative layer/curable resin layer, and curable resin layer/print layer/curable resin layer.

While the active energy ray-curable resin composition of the present invention may be formed into a film of any thickness, the film typically has a thickness of about 0.5 to about 50 μm Other layers may also have any suitable thickness, but are typically formed to a thickness of about 0.5 to about 50 μm.

While the formable laminate of the present invention as described above may be stored without any further processing, it may be laminated with a masking film for storage.

The active energy ray-curable resin composition of the present invention can be used not only in the formable laminate, but also in a transfer membrane in which the substrate is a base film and the active energy ray-curable resin layer is a transfer layer. The base film may include a peelable layer. The transfer membrane has the base film, which may include the peelable layer, and the active energy ray-curable resin layer formed of the active energy ray-curable resin composition laminated onto the base film. Such a transfer membrane is also encompassed by the present invention.

The base film that may include a peelable layer may be a film of acrylic resins, PET, polycarbonate, polystyrene, styrene-acrylic copolymers vinyl chloride resins, polyolefin and ABS (acrylonitrile-butadiene-styrene) copolymers. The base film may include a release layer, which may be provided by a known mold release treatment such as silicone treatment and olefin treatment.

The side of the base film, which may include a release layer, facing the transfer layer may be roughened to impart the dimming property to the surface. The reason why this is advantageous is described in the following.

There has been a great need for a transfer technique that can give the surface of displays and other optical devices not only the hard coat property, but also the dimming property. One such technique that has been proposed is to use a transfer membrane in which a layer containing fine particles is formed on a smooth substrate (Japanese Patent Application Laid-Open No. Hei 8-146525 and Japanese Patent Application aid-Open No. Hei 8-219307). In this tripe of transfer membrane, however, light tends to diffuse within the transfer layer due to the difference in refractive index between the matrix and the particles, resulting in a decrease in the total light transmittance. In addition the particles depending on their shape may function as lenses that cause glare on the display. Furthermore, some materials used to make the particles are too soft to ensure sufficient surface hardness. For these reasons, the base film that may include a release layer may has an uneven surface on its side facing the transfer layer in order to provide the transfer membrane with the dimming property. The term “uneven surface” as used herein means that the surface has a roughness (in other words, a difference between ridges and troughs of the uneven surface) ranging from 01 μm to 10 μm.

The transfer membrane of the present invention can be manufactured by applying the active energy ray-curable resin composition to the surface of the base film, which may include a release layer, by using techniques such as Impregnation, roll coating (as used in letterpress printing, lithographic printing, intaglio printing and other printing processes) spraying and curtain flow coating. The uncured active energy ray-curable resin layer is deposited on the outermost surface of the transfer layer. When the active energy ray-curable resin composition contains a diluent (solvent), it is preferably removed by heating with a heat oven, a far-infrared oven or an ultra far-infrared oven. This completes the transfer membrane of the present invention. The transfer membrane can be wound on a roll since the transfer layer lacks tackiness. The wound transfer membrane can be unwound for use. In certain applications, the transfer membrane may be laminated with a masking film for storage.

The transfer layer of the transfer membrane of the present invention may be formed as a single layer of the active energy ray-curable resin composition or as a multilayered structure including a thermoplastic resin layer and a curable resin layer. The surface of the base film may be made hydrophilic prior to deposition of the functional layer including a curable resin layer having a layer of the active energy ray-curable resin composition of the present invention. Such a functional layer may have the curable resin layer of the present invention a color layer and an antimicrobial layer.

Depending on its intended purpose, the transfer membrane of the present invention may include layers other than those described above, including decorative layers, such as antireflection layers, print layers and color layers, vapor-deposited layers (conductive layers) made of metals or metal compounds, and primer layers. The transfer membrane may have any of the following layered structures curable resin layer, antireflection layer/curable resin layer, print layer/antireflection layer/curable resin layer, primer layer/curable resin layer/curable resin layer/print layer, curable resin layer/decorative layer, and curable resin layer/print layer/curable resin layer.

The antireflection layer in the transfer membrane of the present invention includes at least one layer having a low refractive index. The antireflection layer may be formed as a multilayered structure having alternating layers of a low-index material and a high-index material. In other words, the antireflection layer may have a single layer of a low-index material or may include two or more layers of other low-index materials, high-index materials and polymers. Specifically, the antireflection layer may have any of the following layered structures a single low-index layer, a two-layered structure of low-index layer/high-index layer, and a three-layered structure of low-index layer/high-index layer/low-index layer. The low-index layer preferably has a refractive index of 1.2 to 1.5, and more preferably 1.2 to 1.4. The high-index layer preferably has a refractive index of 1.5 to 2.0, and more preferably 1.6 to 20. These indices may vary depending on the refractive index of the article to which to transfer the transfer membrane. The difference in refractive index between the two layers is preferably 0.2 to 0.8. Sufficient antireflection performance may not be obtained when the two indices are too close, whereas it is difficult to find a practical material for each layer when the difference in refractive index is too large. The at least one low-index layer to form the antireflection layer is typically about 0.05 to about 1 μm thick although it may have any proper thickness. The layers other than the at least one low-index layer are typically about 0.5 to about 50 μm thick each although the layers may have any proper thicknesses.

While the above-described curable resin layer may have any proper thickness, it is typically about 0.5 to about 50 μm thick. The other layers are also about 0.5 to about 50 μm thick each although they may have any proper thicknesses.

The laminate of the present invention can be irradiated with an active energy ray to make a cured laminate. Specifically, the cured laminate can be produced by irradiating an active energy ray onto the active energy ray-curable resin layer of the laminate of the present invention to cure the resin layer, thus forming a cured resin layer on the substrate. Such a production method and the cured laminate obtained by the method are also encompassed by the present invention.

The formable laminate of the present invention can be processed by a two-step method to make a cured laminate shaped article. The two steps step (1) and step (2), are described below. Such a production method is also encompassed by the present invention, as is the cured laminate shaped article obtained by the method.

### Step (1)

In this step, the formable laminate of the present invention is heated to a shaping temperature and is shaped to make a processed article. The shaping may be done by known sheet shaping techniques such as vacuum molding, blow molding and press forming. The shaping temperature may vary depending on the type of the formable substrate and the desired shape of finished articles. When an about 2 mm-thick acrylic resin plate is used as the formable substrate, the laminate is heated to have a surface temperature of about 150° C. The laminate may be shaped in air or nitrogen atmosphere A support may be used during shaping of the laminate. The laminate may be placed in a mold with the functional layer on the side facing the mold or on the opposite side.

### Step 2)

in this step, an active energy ray is Irradiated onto the active energy ray-curable resin layer of the processed article to cure the resin layer and to thus make a cured resin layer. This gives a cured laminate shaped article that has a hard coat layer formed on its surface. The resulting hard coat layer has high scratch-resistance. A wide range of the active energy ray may be used for this purpose, including ultraviolet rays, visible light, laser, electron beams and X-rays. Of these, ultraviolet rays are most suitable for practical use. Specific examples of the sources of ultraviolet rays include low-pressure mercury lamps, high-pressure mercury lamps, xenon lamps and metal halide lamps. The active energy ray may be irradiated using a belt conveyor-type source, a batch-type source or a portable source. The cured laminate shaped article may be post-heated to cure the part that have been insufficiently irradiated with the active energy ray. The post-heating is preferably carried out at about 40° C. to about 100° C., and more preferably at about 50° C. to about 70° C.

The transfer membrane of the present invention can be processed by a two-step method to make a laminate-transferred article. The two steps, step (I) and step (II), are described below. Such a production method is also encompassed by the present invention, as is the cured laminate-transferred article obtained by the method

### Step (I)

In this step, the transfer layer of the transfer membrane of the present invention is held in contact with the article to which to transfer the transfer layer. Specifically, applying heat to the curable resin layer of the active energy ray-curable resin composition at the outermost surface of the transfer layer while the resin layer is held in contact with the article transfers the transfer layer to the surface of the article. The transfer layer can be held in contact with the article and heated by any proper technique. Following this step, the base film of the transfer membrane may be peeled. While the article to which to transfer the transfer membrane may be of any shape, it is preferably a plate or a film of acrylic resins, PET, polycarbonate, polystyrene, styrene-acrylic copolymers, vinyl chloride resins, polyolefin and ABS (acrylonitrile-butadiene-styrene) copolymers, a plastic substrate formed of cycloolefin polymers, or a substrate formed of thermosetting resins. The substrate for use in a typical shaping process is preferably 0.1 mm to 50 mm thick although it may have any desired thickness.

### Step (II)

In this step, the article having the transfer layer transferred in the step (I) thereto is irradiated with an active energy ray to cure the active energy ray-curable resin layer in the transfer layer and to thus make a cured resin layer. This gives a laminate-transferred article that has a hard coat layer formed on its surface. The resulting hard coat layer has high scratch-resistance. When the base film is not peeled off the transferred membrane in the step (I), it may be peeled after this step. The base film may not be peeled throughout the two steps.

The cured laminate shaped article and the laminate-transferred article preferably have a pencil hardness of 2H or higher and more preferably 3H or higher, to ensure scratch resistance. The article having a pencil hardness of H or below is susceptible to scratches and is not suitable.

The cured laminate shaped article and the laminate-transferred article of the present invention preferably has a surface resistivity of 1.0×10¹³Ω/□ or lower, more preferably 1.0×10¹³Ω/□ or lower, to ensure antifouling property. The article with surface resistivity of higher than 1.0×10¹⁴Ω/□ susceptible to adhesion of dust particles and is net suitable. □

A base film that has an uneven surface on the side facing the transfer layer may be used in the cured laminate shaped article or the laminate-transferred article of the present invention to provide the articles with dimming properties. The resulting cured laminate shaped article or the laminate-transferred article preferably has a haze value of 5 to 501, and more preferably 10 to 45%. The cured laminate shaped article or the laminate-transferred article that has too low a haze value does not have sufficient dimming property, whereas the article having too high a haze value shows a decreased total light transmittance.

The cured laminate shaped article or the laminate-transferred article of the present invention preferably has a total light transmittance of 800 or higher more preferably 85- or higher. The cured laminate shaped article or the laminate-transferred article that has a total light transmittance of less than 80% tends to have a decreased brightness and is not suitable.

The laminate-transferred article as one embodiment of the present invention can be used in different applications depending on the type, thickness and physical properties of the article to which to transfer the transfer membrane, as well as on the physical properties and thickness of the transfer layer to form the transfer membrane and additional layers. For example the laminate-transferred article of the present invention is suitable for use in screen protection panels of cathode ray tube televisions, liquid crystal display televisions plasma display televisions and projection televisions. Such a screen protection panel is also encompassed by the present invention.

The laminate of the present invention can be processed by a printing method comprising the steps (i) through (iii) to make a printed article. Such a printing method is also encompassed by the present invention.

### Step (i)

In this step, the active energy ray-curable resin layer of the present invention is partially irradiated with an active energy ray to cure the active energy ray-curable resin layer only where it is irradiated with the active energy ray. This results in the formation of cured areas and uncured areas in the active energy ray-curable resin layer. The partial irradiation with active energy ray can be done by any known technique, including masking, dot drawing and line drawing. While a wide range of active energy rays can be used to irradiate the active energy ray-curable resin layer, including ultraviolet rays, visible light, laser, electron beams and x-rays, ultraviolet rays are most practical. Specific examples of the sources of ultraviolet rays include low-pressure mercury lamps, high-pressure mercury lamps, xenon lamps and metal halide lamps.

### Step (ii)

In this step, a patterning resin layer is laminated and pressed onto the active energy ray-curable resin layer of the laminate obtained in the step (i). The patterning resin layer is formed of a patterning resin composition comprising 50 mass % to 95 mass % of an inorganic filler mixed with a binder.

Although the pressing roll may be used at about 25° C., it is preferably heated to a temperature above the glass transition temperature of the active energy ray-curable resin composition to make an exposure layer. More preferably the roll is heated to 50° C. to 180° C.

Examples of the inorganic filler include pure metals, metal oxides and carbon black. Examples of the pure metal include Fe, Ni, Cu, Zn, Pd, Ag, Pt and Au. Examples of the metal oxide include silica, aluminum oxide, indium/tin composite oxide zinc oxide and analogues thereof. Silica and carbon black are preferably used in order to improve the adhesion between active energy ray-curable resin layer and the patterning resin layer. These inorganic fillers may be of any known shape, including spheres needles, pillars and non-uniform shapes. Of these, spheres are particularly preferred to improve the accuracy of printing. To ensure the accuracy of printing, the inorganic fillers preferably have a size of 20 nm to 100 μm, more preferably 20 nm to 30 μm, as measured by the radius for spheric fillers and by the length of the minor axis for needle- and pillar-shaped fillers.

When the amount of the inorganic filler in the patterning resin composition is less than 50 mass %, the adhesion between the active energy ray-curable resin layer and the patterning resin layer tends to decrease. When the amount of the inorganic filler is more than 95 mass %, the patterning layer tends to become too hard to ensure accuracy of printing. Thus, the inorganic filler is dispersed in a binder. Examples of the binder include curable resins, including thermoplastic polymers, thermosetting resins and photocurable resins, such as (meth)acrylic resins and polyester resins, and curable resins.

The patterning resin layer is preferably 0.1 μm to 30 μm thick, and more preferably 1 μm to 10 μm thick. The patterning resin layer that is too thick tends to result in a decreased accuracy of printing, whereas the patterning resin layer that is too thin tends to result in a reduced contrast.

In the step (ii), the patterning resin layer can be laminated onto the active energy ray-curable resin layer by using techniques such as impregnation, roll coating (as used in letterpress printing, lithographic printing, intaglio printing and other printing processes), spraying and curtain flow coating.

The patterning resin layer can be laminated onto the active energy ray-curable resin layer by using a transfer membrane Such a transfer membrane has a base film that may include a release layer and at least the patterning resin layer laminated to the base film. The patterning resin layer may be combined with a binder layer and a protective layer to make a transfer layer. Specific examples of the base film may include acrylic resins PET, polycarbonate, polystyrene styrene-acrylic copolymers vinyl chloride resins, polyolefin and ABS (acrylonitrile-butadiene-styrene) copolymers. The transfer layer may be a patterning resin layer alone, or may be constituted of protective layer/color layer or color layer/binder layer. These layered structures are used depending on intended applications. The base film may be release-treated. One example of release treatment is coating with a silicone resin or olefin resin.

In the step (ii) the patterning resin layer may be laminated or pressed onto the active energy ray-curable resin layer by pressing the patterning layer with a roll, or a film may be sandwiched between the roll and the patterning resin layer. Although in the step (ii) the color layer may be laminated to the laminate obtained in the step (i) at about 25° C. it is preferably laminated at 30 to 100° C.

Step (iii)

In this step, the patterning resin layer formed on the cured areas of the active energy ray-curable resin layer of the laminate obtained in the step (ii) is removed, leaving the patterning resin layer only on the uncured areas. As a result, a resin pattern is formed. Thus, the resin pattern is printed only on the uncured areas of the active energy ray-curable resin layer of the laminate. The patterning resin layer on the cured areas of the active energy ray-curable resin layer can be removed by blowing with an airbrush, scraping with a brush, or applying a pressure sensitive adhesive film to the color layer so that the adhesive surface adheres to the color layer and then peeling the film. When a transfer membrane is used, the peelable base of the transfer membrane may be peeled off from the laminate to remove the patterning resin layer.

In the step (i), the substrate of the laminate may be flat on one side surface and contain a plurality of aligned convex lenses on the other side surface. The active energy ray-curable resin layer is laminated onto the flat surface of the substrate to form the laminate. Irradiating the laminate from the convex lens surface side of the substrate with an active energy ray and subjecting the laminate to a particular printing method can produce printed articles. In this printing method, a colorant-containing patterning resin composition is used in the step (ii) and the patterning resin layer forms a light-blocking pattern. Such a printing method is also encompassed by the present invention.

Although, as described above, the printed articles obtained by the printing method comprising the steps (i) through (iii) may be directly used as a lenticular sheet or other optical elements or printed articles that include light-blocking patterns, the articles may be further laminated with a hard coat layer or an antistatic layer. In other words, one aspect of the printing method of the present invention concerns a production method of a laminate product that has a substrate, an exposure layer deposited on the substrate and a resin pattern deposited on the exposure layer. The method involves the above-described steps (i) through (iii).

Following the step (iii) the entire active energy ray-curable resin layer is preferably irradiated with the active energy ray to cure the entire layer as a step (iv). The active energy ray-curable resin layer can be cured by any of the following irradiation techniques Irradiating such a resin layer with an active energy ray without an exposure mask; irradiating an entire resin pattern with an active energy ray so that the active energy ray is transmitted through the resin pattern; and when the substrate is a lenticular lens, irradiating with an active energy ray scattered by the lenticular lens surface. Curing the entire active energy ray-curable resin layer can improve the durability of the active energy ray-curable resin layer in the uncured areas.

The above-described printing method can be used to produce printed articles. Such printed articles are also encompassed by the present invention. In particular, the printing method of the present invention can be used to make lenticular lens sheets when the patterning resin layer serves as a light-blocking pattern. Such a lenticular lens sheet is also encompassed by the present invention.

### EXAMPLES

The present invention will now be described with reference to examples, which are not intended to limit the scope of the invention in any way. In examples and comparative examples that follow, the following properties are measured or evaluated: weight average molecular weight (Mw), molecular weight distribution (Mw/Mn), glass transition temperature (Tg), tackiness, how the requirements (A) through (C) and (E) are each met, handleabiliry, formability, pencil hardness, scratch resistance, adhesion, storage stability surface resistivity, haze value, total light transmittance, minimum reflectance, and oil film-like interference pattern. The measurement and evaluation of each property were performed in the manner described below.

Weight average molecular weight (Mw) and molecular weight distribution (Mw/Mn)

Weight average molecular weight (Mw) and molecular weight distribution (Mw/Mn) of curable resin composition in its uncured state were measured by gel permeation chromatography (GPC) (8020 series, available from Tosoh). The weight average molecular weight (Mw) was determined using polystyrene standards

Class Transition temperature (Tg; ° C.)

Glass transition temperature (Tg) of each curable resin composition in its uncured state was measured by a differential scanning calorimeter (TA4000, available from Mettler.

### Tackiness

Tackiness was measured as the greatest ball number in a rolling ball tack test (jIS 20237). A larger ball number indicates a stronger tackiness.

How the Requirements (A) Through (C) and (E) were Met.

A mark “G” was given when the requirement was met, a mark “NG” when not.

### Handleablity

5 sheets of formable laminate were stacked. A 5 kg weight was placed on the stack. The stack with the weight placed on it was then left in a dark environment for 12 hours and each laminate was observed for surface condition.

### Formability

Each cured laminate shaped article was visually observed for the presence of cracks.

### Pencil Hardness

Each cured laminate shaped article was evaluated for the pencil hardness according to the technique described in JIS K5600-5-4. A pencil hardness of 2H or higher is desirable for practical use.

### Scratch Resistance

Steel wool was placed underneath the cured laminate shaped article and the article was rubbed against the steel wool 100 times while a 500 g load was applied. The increase in the haze of the article was then measured. A 10% or less increase in the haze is desirable for practical use.

### Adhesion

The adhesion between the PMMA plate and the transfer layer of the laminate-transferred article was evaluated according to JIS K5400.

### Storage Stability

Transfer membrane was cut into A4 size sheets. Five of these sheets were stacked and a 5 kg weight was placed on the stack. The stack with the weight placed on it was left in a dark environment for 2 months. Using a roll heated to 160° C., the transfer membrane was transferred to a 2 mm-thick acrylic resin plate heated to 80° C. at a roll speed of 1 m/min. The transfer performance of the transfer membrane was evaluated. A good transfer performance can be interpreted that the transfer membrane has good storage stability

### Surface Resistivity

Laminate-transferred article was stored at 25° C., 50% R^{H}, for 1 week and was evaluated according to JIS K6911.

### Haze Value

Laminate-transferred article was evaluated according to JIS K₇₁₀₅-6.4.

### Total Light Transmittance

Laminate-transferred article was evaluated according to JIS K7105-55.2.

### Minimum Reflectance

Laminate-transferred article was analyzed for minimum reflectance on the side having the transfer layer. This was done by measuring 5° regular reflectance in the visible range (400 to 700 nm) by a spectrophotometer (U-4000, available from Hitachi) and recording the minimum value.

### Oil Film-Like Interference Pattern

Laminate-transferred article was mounted on a projection television with the transfer layer facing viewer side 10 randomly selected viewers were asked to visually observe the TV screen for the presence or absence of oil film-like interference patterns. When all of the viewers agreed that a TV screen had significantly decreased interference patterns as compared to Comparative Example 3, the laminate-transferred article on that TV was rated as acceptable (as indicated by a mark “3”). Otherwise, the TV was rated as unacceptable (as indicated by a mark “NG”).

### Synthesis Example

Methyl isobutyl ketone (36 g) and one of the polymerizable monomer compositions shown in Table 1 (24 g) were placed in a 100 ml three-necked flask. The air in the flask was replaced by nitrogen and 2,2′-azobisisobutyronitrile (40 mg) was added. The resulting mixture was stirred at 80° C. for 6 hours to give a polymerization solution.

TABLE 1

| | | Polymerization solution | | | | | | |
|---|---|---|---|---|---|---|---|---|
| | | P-1 | P-2 | P-3 | P-4 | P-5 | P-6 | P-7 |
| Methylmethacrylate | Wt pts | 20 | 35 | 80 | 30 | 0 | 50 | 0 |
| 2-ethylhexylacrylate | Wt pts | 0 | 0 | 0 | 5 | 0 | 0 | 0 |
| Styrene | Wt pts | 0 | 0 | 0 | 0 | 50 | 0 | 0 |
| MPTMS *¹ | Wt pts | 80 | 65 | 20 | 65 | 50 | 0 | 0 |
| MPTES *² | Wt pts | 0 | 0 | 0 | 0 | 0 | 50 | 100 |
| Mw (×10³) *³ | — | 116 | 124 | 260 | 96 | 53 | 75 | 152 |
| Mw/Mn *³ | — | 2.2 | 3.3 | 3.9 | 2.9 | 1.7 | 2.0 | 2.3 |
| b/a *⁴ | — | 0.62 | 0.43 | 0.09 | 0.44 | 0.30 | 0.25 | 1.00 |

(Table 1, Note)
*¹ γ-methacryloyloxypropyltrimethoxysilane (trade name: KBM-503, available from Shin-etsu chemical)
*² γ-methacryloyloxypropyltriethoxysilane (trade KBE-503, available from Shin-etsu chemical)
*³ Ratio of the number of alkoxysilyl groups (b mol) in one molecule to the number of monomer units (a mol) in one molecule.

### Examples 1 through 7 and Comparative Examples 1 through 6

### Preparation of Resin Composition, Formable Laminate and Cured Laminate Shaped Article)

Each of the resin compositions shown in Table 2 was applied to a 30 cm (L)×21 cm (W)×2 mm (T) acrylic resin plate (trade name: COMOGLAS, available from Kuraray Co. Ltd) to a film thickness 10 μm except for Comparative Example 5). The coating was dried at 80° C. for 30 sec to obtain a formable laminate. The formable laminate was heated at 190° C. for 3 min and was formed by vacuum into a 20 cm×10 cm×10 cm box (maximum area stretch ratio=25 times). This box was irradiated with UV (at a dose of 2 J. HTE-3000B, available from Hi-tech) to obtain a cured laminate shaped article. The results of the measurement and evaluation of the resin compositions, the formable laminates and the cured laminate shaped articles obtained in Examples and Comparative Examples are collectively shown in Table 2.

### Examples 8 Through 10

### Preparation of Transfer Membrane and Cured Laminate Shaped Article

Each of the resin compositions used in Examples 1 through 3 is applied to a polyethylene terephthalate (PET) film to a film thickness of 10 μm. The coating was dried at 80° C. for 30 sec to obtain a transfer membrane having a resin composition layer (i.e., transfer layer) deposited on the PET film. Using a roll heated to 160° C., the transfer layer of this transfer membrane was transferred to a 2 mm-thick acrylic resin plate heated to 80° C. at a roll speed of 1 m/min to obtain a formable laminate. The formable laminate was heated at 190° C. or 3 min and was formed by vacuum into a 20 cm (L)×10 cm (W)×10 cm (H) box (maximum area stretch ratio=25 times). This box was irradiated with UV rays (at a dose of 2 J, available from HTE-3000B, available from Hi-tech) to obtain a cured laminate shaped article. The results of the measurement and evaluation of the resin compositions, the formable laminates and the cured laminate shaped articles obtained in Examples are collectively shown in Table 2.

TABLE 2

| | | Example | | | | | | | | | |
|---|---|---|---|---|---|---|---|---|---|---|---|
| | | 1 | 2 | 3 | 4 | 5 | 6 | 7 | 8 | 9 | 10 |
| P-1 | Wt pts | 20 | 0 | 0 | 0 | 0 | 0 | 18 | 20 | 0 | 0 |
| P-2 | Wt pts | 0 | 20 | 0 | 0 | 0 | 0 | 0 | 0 | 20 | 0 |
| P-3 | Wt pts | 0 | 0 | 20 | 0 | 0 | 0 | 0 | 0 | 0 | 20 |
| P-4 | Wt pts | 0 | 0 | 0 | 20 | 0 | 0 | 0 | 0 | 0 | 0 |
| P-5 | Wt pts | 0 | 0 | 0 | 0 | 20 | 0 | 0 | 0 | 0 | 0 |
| P-6 | Wt pts | 0 | 0 | 0 | 0 | 0 | 20 | 0 | 0 | 0 | 0 |
| P-7 | Wt pts | 0 | 0 | 0 | 0 | 0 | 0 | 20 | 0 | 0 | 0 |
| Photoacid generator *¹ | Wt pts | 1 | 1 | 1 | 1 | 1 | 1 | 1 | 1 | 1 | 1 |
| Silica sol A *² | Wt pts | 0 | 0 | 0 | 0 | 0 | 0 | 2 | 0 | 0 | 0 |
| Silica sol B *³ | Wt pts | 0 | 0 | 0 | 0 | 0 | 0 | 0 | 0 | 0 | 0 |
| Urethane acrylate *⁴ | Wt pts | 0 | 0 | 0 | 0 | 0 | 0 | 0 | 0 | 0 | 0 |
| Photopolymerization | Wt pts | 0 | 0 | 0 | 0 | 0 | 0 | 0 | 0 | 0 | 0 |
| initiator *⁵ | | | | | | | | | | | |
| Methyl isobutyl ketone | Wt pts | 30 | 30 | 30 | 30 | 30 | 30 | 30 | 30 | 30 | 30 |
| Methyl ethyl ketone | Wt pts | 49 | 49 | 49 | 49 | 49 | 49 | 49 | 49 | 49 | 49 |
| Tg | ° C. | 22.8 | 30.0 | 64.6 | 26.1 | 37.0 | 28.3 | 25.8 | 22.8 | 30.0 | 64.6 |
| Tackiness | — | 1 | 1 | 1 | 1 | 1 | 1 | 1 | 1 | 1 | 1 |
| Requirement (A) | — | G | G | G | G | G | G | G | G | G | G |
| Requirement (B) | — | G | G | G | G | G | G | G | G | G | G |
| Requirement (C) | — | G | G | G | G | G | G | G | G | G | G |
| Handleability | — | Good | Good | Good | Good | Good | Good | Good | Good | Good | Good |
| Formability | — | Good | Good | Good | Good | Good | Good | Good | Good | Good | Good |
| Pencil hardness | — | 5H | 4H | 4H | 4H | 4H | 4H | 5H | 5H | 4H | 4H |
| Scratch resistance | % | 2.0 | 0.3 | 0.2 | 0.4 | 0.3 | 0.3 | 2.0 | 2.0 | 0.3 | 0.2 |

| | | Comparative Example | | | | | |
|---|---|---|---|---|---|---|---|
| | | 1 | 2 | 3 | 4 | 5 | 6 |
| P-1 | Wt pts | 0 | 15 | 15 | 0 | acrylic | 17 |
| P-2 | Wt pts | 0 | 0 | 0 | 0 | resin | 0 |
| P-3 | Wt pts | 0 | 0 | 0 | 0 | plate | 0 |
| P-4 | Wt pts | 0 | 0 | 0 | 0 | only | 0 |
| P-5 | Wt pts | 0 | 0 | 0 | 0 | | 0 |
| P-6 | Wt pts | 0 | 0 | 0 | 0 | | 0 |
| P-7 | Wt pts | 20 | 0 | 0 | 0 | | 0 |
| Photoacid generator *¹ | Wt pts | 1 | 1 | 1 | 0 | | 1 |
| Silica sol A *² | Wt pts | 0 | 5 | 0 | 0 | | 3 |
| Silica sol B *³ | Wt pts | 0 | 0 | 5 | 0 | | 0 |
| Urethane acrylate *⁴ | Wt pts | 0 | 0 | 0 | 20 | | 0 |
| Photopolymerization | Wt pts | 0 | 0 | 0 | 1 | | 0 |
| initiator *⁵ | | | | | | | |
| Methyl isobutyl ketone | Wt pts | 30 | 30 | 30 | 30 | | 30 |
| Methyl ethyl ketone | Wt pts | 49 | 49 | 49 | 49 | | 49 |
| Tg | ° C. | 9.0 | 76.6 | 72.3 | −34.2 | — | 53.4 |
| Tackiness | — | 3 | 1 | 1 | 4 | — | 1 |
| Requirement (A) | — | G | G | G | NG | — | G |
| Requirement (B) | — | NG | G | G | NG | — | G |
| Requirement (C) | — | G | NG | NG | NG | — | NG |
| Handleability | — | Significant | Good | Good | Significant | Good | Good |
| | | scratches | | | Damage | | |
| Formability | — | Good | Cracks | Cracks | Cracks | Good | Cracks |
| Pencil hardness | — | 4H | N/A | N/A | N/A | H | N/A |
| Scratch resistance | % | 0.3 | N/A | N/A | N/A | 18 | N/A |

(Table 2, Note)
*¹ p-((2-dodecyl)-(2-hydroxy)ethoxy)phenyl, phenyliodonium tetrafluorophophate; trade name: SarCat CD-1012, available from Sartmer
*² trade name: MEK-ST, Nissan chemical industries, figures in Table 2 indicate solid contents.
*³ 80 g of methyltrimethoxysilane (trade name: KBM-13, available from Shin-etsu chemical) and 16 g of ion-exchanged water were placed in a 200 ml three-necked flask. The mixture was stirred at 60° C. for 6 hours to hydrolyze methyltrimethoxysilane (trade name: KBM-13, available from Shin-etsu chemical). Subsequently, methyl isobutyl ketone was added dropwise and the methanol by-product produced during hydrolysis was evaporated. This gave a polysiloxane solution having a solid content of 40 mass %. Figures in Table 2 indicate solid contents.
*⁴ trade name: Artresin UN3320HC, available from Negami chemical industrial
*⁵ trade name: Irgacure 184, available from Ciba specialty chemicals

As an be seen from Table 2G each of the formable laminates of Examples 1 through 10 made by using the respective resin compositions of the present invention meets the requirements (A) through tC). Thus, each of these formable laminates can be readily handled in its uncured state, is highly formable, and can be used to make a cured laminate shaped article having high hard coat property. In contrast, the formable laminate of Comparative Example 1, which meets the requirements (A) and (C) but not the requirement (B), is susceptible to scratches and is thus less handleable. The formable laminates of Comparative Examples 2, 3 and 6, each of which meets the requirements (A) and (B) but not the requirement (C), cracked during the forming process. This demonstrates that these formable laminates are defective not only in their formability, but also in their pencil hardness and scratch resistance Not meeting any of the requirements (A) through (C), the formable laminate of Comparative Example 4 has a very low glass transition temperature. The results further indicate that this laminate is defective not only in its handleability and formability, but also in its pencil hardness and scratch resistance. Comparative Example 5, which is provided as a simple acrylic resin plate rather than a laminate, does not have sufficient pencil hardness or scratch resistance.

### Example 11

### Preparation of Transfer Membrane and Laminate-Transferred Article

As shown in Table 3, the resin composition used in Example 1 was applied to a PET film to a film thickness of 10 μm. The coating was then dried at 80° C. for 30 sec to obtain a transfer membrane having a resin composition layer (i.e., transfer membrane) deposited on the PET film. The transfer membrane was placed in a mold (an injection mold having a curved surface (R=30 mm) and a 5 mm step with a draft angle of 5 degrees.) with the transfer layer held in contact with the formable resin. The mold was mounted on an injection molding machine (SG150, available from Sumitomo heavy industries) and an acrylic resin (PARAPET HR-L, available from Kuraray Co., Ltd.) was injected into a cavity of the mold (molding temperature=280° C., mold temperature=80° C.). After cooling, the molded article was taken out of the mold. The base film of the transfer membrane was then peeled. The surface of the article having the transfer layer transferred thereto was irradiated with UV rays (at a dose of 2 J. HTE-3000B, available from Hi-tech) to obtain a laminate-transferred article. The resulting laminate-transferred article had good surface condition and had a pencil hardness of 3H. The transfer membrane in its uncured state was readily handleable, had a good formability, and can be used to make a laminate-transferred article having high hard coat property (Table 3).

### Examples 12 Through 17 and Comparative Examples 7 Through 9

### Preparation of Transfer Membrane and Laminate-Transferred Article

Each of the resin compositions shown in Table 3 was applied to a 38 μm-thick PET film (trade name: Lumilar S10#38, available from Toray industries, to a film thickness of 5 m. The coating was dried at 80° C. for 30 sec to obtain a transfer membrane having a resin composition layer (i.e., transfer layer) deposited on the PET film. The transfer layer of the transfer membrane was held against a 2 mm-thick pol ethylmethacrylate plate heated to 80° C. Using a roll heated to 1° C., the transfer layer was transferred to the PMMA plate at a roll speed of 1 m/min. The PET film was peeled and the transfer layer was irradiated with UV rays (2 v, HTE-3000B, available from Hi-tech) to obtain a laminate-transferred article. The results of the measurement and evaluation of the resin compositions and the laminate-transferred articles in Examples and comparative Examples are collectively shown in Table 3.

### Examples 18 and 19

### Preparation of Transfer Membrane and Laminate-Transferred Article

The process was carried out in the same manner as in Example 1, except that the article to which to transfer the transfer layer was an MS resin plate (Example 18) or a polycarbonate resin plate Example 193. Evaluation was performed as in Example 1 The results are shown in Table 3.

TABLE 3

| | | Example | | | | | | | | | Comparative Example | | |
|---|---|---|---|---|---|---|---|---|---|---|---|---|---|
| | | 11 | 12 | 13 | 14 | 15 | 16 | 17 | 18 | 19 | 7 | 8 | 9 |
| P-1 | Wt pts | 20 | 20 | 0 | 0 | 0 | 0 | 0 | 20 | 20 | 0 | 15 | 15 |
| P-2 | Wt pts | 0 | 0 | 20 | 0 | 0 | 0 | 0 | 0 | 0 | 0 | 0 | 0 |
| P-3 | Wt pts | 0 | 0 | 0 | 20 | 0 | 0 | 0 | 0 | 0 | 0 | 0 | 0 |
| P-4 | Wt pts | 0 | 0 | 0 | 0 | 20 | 0 | 0 | 0 | 0 | 0 | 0 | 0 |
| P-5 | Wt pts | 0 | 0 | 0 | 0 | 0 | 20 | 0 | 0 | 0 | 0 | 0 | 0 |
| P-6 | Wt pts | 0 | 0 | 0 | 0 | 0 | 0 | 20 | 0 | 0 | 0 | 0 | 0 |
| P-7 | Wt pts | 0 | 0 | 0 | 0 | 0 | 0 | 0 | 0 | 0 | 20 | 0 | 0 |
| Photoacid generator *¹ | Wt pts | 1 | 1 | 1 | 1 | 1 | 1 | 1 | 1 | 1 | 1 | 1 | 1 |
| Silica sol A *² | Wt pts | 0 | 0 | 0 | 0 | 0 | 0 | 0 | 0 | 0 | 0 | 5 | 0 |
| Silica sol B *³ | Wt pts | 0 | 0 | 0 | 0 | 0 | 0 | 0 | 0 | 0 | 0 | 0 | 5 |
| Photopolymerization initiator *⁵ | Wt pts | 0 | 0 | 0 | 0 | 0 | 0 | 0 | 0 | 0 | 0 | 0 | 0 |
| Surfactant 1 *⁶ | Wt pts | 0 | 1 | 0 | 0.2 | 0.2 | 0.2 | 0.2 | 0 | 0 | 1 | 1 | 1 |
| Surfactant 2 *⁷ | Wt pts | 0 | 0 | 0.2 | 0 | 0 | 0 | 0 | 0 | 0 | 0 | 0 | 0 |
| Methyl isobutyl ketone | Wt pts | 30 | 30 | 30 | 30 | 30 | 30 | 30 | 30 | 30 | 30 | 30 | 30 |
| Methyl ethyl ketone | Wt pts | 49 | 48 | 48.8 | 48.8 | 48.8 | 48.8 | 48.8 | 49 | 49 | 48 | 48 | 48 |
| Tg | ° C. | 22.8 | 22.8 | 30.0 | 64.6 | 26.1 | 37.0 | 28.3 | 22.8 | 22.8 | 9.0 | 76.6 | 72.3 |
| Tackiness | — | 1 | 1 | 1 | 1 | 1 | 1 | 1 | 1 | 1 | 3 | 1 | 1 |
| Requirement (A) | — | G | G | G | G | G | G | G | G | G | G | G | G |
| Requirement (B) | — | G | G | G | G | G | G | G | G | G | NG | G | G |
| Requirement (C) | — | G | G | G | G | G | G | G | G | G | G | NG | NG |
| Adhesion (×100) | — | 100 | 100 | 100 | 100 | 100 | 100 | 100 | 100 | 100 | 100 | N/A | N/A |
| Pencil hardness | — | 3H | 5H | 4H | 4H | 4H | 4H | 4H | 3H | 3H | 5H | N/A | N/A |
| Scratch resistance | % | 2.0 | 2.0 | 0.3 | 0.2 | 0.4 | 0.3 | 0.3 | 0.2 | 0.3 | 0.2 | N/A | N/A |
| Storage stability | — | Good | Good | Good | Good | Good | Good | Good | Good | Good | Significant | Transfer | Transfer |
| | | | | | | | | | | | scratches | failure | failure |
| Handleability | — | Good | Good | Good | Good | Good | Good | Good | Good | Good | Significant | Good | Good |
| | | | | | | | | | | | scratches | | |
| Surface resistivity (×10¹¹) | Ω/□ | 100000 | 4.6 | 0.85 | 3.2 | 6.8 | 10 | 6.5 | 3.0 | 0.65 | 30 | N/A | N/A |

(Table 3, Note)
*¹ through *³ and *⁵ are as in Table 2, Note.
*⁶ sodium oleate (available from Wako pure chemical industries)
*⁷ sodium oleyl sulfosuccinate (available from Wako pure chemical industries)

As can be seen from Table 3, each of the transfer membrane of Examples 12 through 19 made by using the respective resin compositions of the present invention meets all of the requirements (A) through (C). Thus, each of them in its uncured state is easy to handle, has high formability and high hard coat property, and can be used to make a laminate-transferred article with high antistatic property. In comparison, the transfer membrane of Comparative Example 7 has a low glass transition temperature and meets only the requirements (A) and (C), but not the requirement (B). Thus, the transfer membrane is susceptible to scratches and is defective in its storage stability and handleability. It also has considerably higher surface resistivity than the transfer membrane of Examples 12 through 19. The transfer membrane of Comparative Examples 8 and 9 each meet the requirements (A) and (B), but not the requirement (C): Neither of them can be transferred properly and have essential performances required of a transfer membrane.

### Examples 20 Through 25 and Comparative Examples 10 Through 12

### Preparation of Resin Composition, Transfer Membrane and Laminate-Transferred Article

Each of the resin compositions shown in Table 4 was applied to a 38 μm-thick rough matte PET film (trade name: Lumilar X42#38, available from Toray industries) to a film thickness of 5 μm (minimum thickness of solid content). The coating was dried at 80° C. for 30 sec to obtain a transfer membrane having a resin composition layer (i.e., transfer layer) deposited on the rough PET film. The transfer layer of the transfer membrane was held against a 2 mm-thick PMMA plate heated to 80° C. Using a roll heated to 160° C., the transfer layer was transferred to the PMMA plate at a roll speed of 1 m/min. The rough PET film was peeled and the transfer layer was irradiated with UV rays (2 J. HTE-3000B, available from Hi-tech) to obtain a laminate-transferred article. The results of the measurement and evaluation of the resin compositions and the laminate-transferred articles in Examples and Comparative Examples are collectively shown in Table 4.

### Comparative Example 13

### Preparation of Laminate

The resin composition shown in Table 4 was applied to a 2 mm-thick PMMA plate to a film thickness of 3 μm thickness of solid content). The coating was dried at 80° C. for 30 sec and was subsequently irradiated with UV rays (80 W high-pressure mercury lamp, conveyor speed=1 m/min, 2 passes) to obtain a laminate The results of the measurement and evaluation of the resin composition and the laminate in Comparative Example are shown in Table 4.

### Examples 26 Through 28

### Preparation of Transfer Membrane and Laminate-Transferred Article

To obtain a laminate-transferred article of Example 26, the same process was performed as in Example 20 except that the substrate of transfer membrane was a 38 μm-thick glossy rough PET film (trade name: Lumilar X44#38, available from Toray industries). To obtain a laminate-transferred article of Example 27, the same process was performed as in Example 20 except that the article to which to transfer the transfer layer was an MS resin plate.

To obtain a laminate-transferred article of Example 28, the same process was performed as in Example 20 except that the article to which to transfer the transfer layer was a polycarbonate resin plate. Evaluation was performed as in Example 20. The results are shown in Table 4.

TABLE 4

| | | Example | | | | | | | | | Comparative Example | | | |
|---|---|---|---|---|---|---|---|---|---|---|---|---|---|---|
| | | 20 | 21 | 22 | 23 | 24 | 25 | 26 | 27 | 28 | 10 | 11 | 12 | 13 |
| P-1 | Wt pts | 20 | 0 | 0 | 0 | 0 | 0 | 20 | 20 | 20 | 0 | 15 | 15 | 0 |
| P-2 | Wt pts | 0 | 20 | 0 | 0 | 0 | 0 | 0 | 0 | 0 | 0 | 0 | 0 | 0 |
| P-3 | Wt pts | 0 | 0 | 20 | 0 | 0 | 0 | 0 | 0 | 0 | 0 | 0 | 0 | 0 |
| P-4 | Wt pts | 0 | 0 | 0 | 20 | 0 | 0 | 0 | 0 | 0 | 0 | 0 | 0 | 0 |
| P-5 | Wt pts | 0 | 0 | 0 | 0 | 20 | 0 | 0 | 0 | 0 | 0 | 0 | 0 | 0 |
| P-6 | Wt pts | 0 | 0 | 0 | 0 | 0 | 20 | 0 | 0 | 0 | 0 | 0 | 0 | 0 |
| P-7 | Wt pts | 0 | 0 | 0 | 0 | 0 | 0 | 0 | 0 | 0 | 20 | 0 | 0 | 0 |
| Photoacid generator *¹ | Wt pts | 1 | 1 | 1 | 1 | 1 | 1 | 1 | 1 | 1 | 1 | 1 | 1 | 0 |
| Silica sol A *² | Wt pts | 0 | 0 | 0 | 0 | 0 | 0 | 0 | 0 | 0 | 0 | 5 | 0 | 0 |
| Silica sol B *³ | Wt pts | 0 | 0 | 0 | 0 | 0 | 0 | 0 | 0 | 0 | 0 | 0 | 5 | 0 |
| Urethane acrylate *⁴ | Wt pts | 0 | 0 | 0 | 0 | 0 | 0 | 0 | 0 | 0 | 0 | 0 | 0 | 40 |
| Crosslinked polystyrene | Wt pts | 0 | 0 | 0 | 0 | 0 | 0 | 0 | 0 | 0 | 0 | 0 | 0 | 80 |
| particles *⁸ | | | | | | | | | | | | | | |
| Surfactant 2 *⁷ | Wt pts | 0 | 0.2 | 0.2 | 0.2 | 0.2 | 0.2 | 0 | 0 | 0 | 0 | 0 | 0 | 0 |
| Photopolymerization | Wt pts | 0 | 0 | 0 | 0 | 0 | 0 | 0 | 0 | 0 | 0 | 0 | 0 | 2 |
| initiator *⁵ | | | | | | | | | | | | | | |
| Methyl isobutyl ketone | Wt pts | 30 | 30 | 30 | 30 | 30 | 30 | 30 | 30 | 30 | 30 | 30 | 30 | 0 |
| Methyl ethyl ketone | Wt pts | 49 | 48.8 | 48.8 | 48.8 | 48.8 | 48.8 | 48.8 | 49 | 49 | 49 | 49 | 49 | 50 |
| Tg | ° C. | 22.8 | 30.0 | 64.6 | 26.1 | 37.0 | 28.3 | 22.8 | 22.8 | 22.8 | 9.0 | 76.6 | 72.3 | −34.2 |
| Tackiness | — | 1 | 1 | 1 | 1 | 1 | 1 | 1 | 1 | 1 | 3 | 1 | 1 | — |
| Requirement (A) | — | G | G | G | G | G | G | G | G | G | G | G | G | NG |
| Requirement (B) | — | G | G | G | G | G | G | G | G | G | NG | G | G | NG |
| Requirement (C) | — | G | G | G | G | G | G | G | G | G | G | NG | NG | NG |
| Adhesion (×100) | — | 100 | 100 | 100 | 100 | 100 | 100 | 100 | 100 | 100 | 100 | N/A | N/A | 100 |
| Pencil hardness | — | 5H | 4H | 4H | 4H | 4H | 4H | 5H | 4H | 4H | 5H | N/A | N/A | 3H |
| Haze value | % | 26.0 | 26.4 | 27.0 | 26.5 | 27.2 | 27.4 | 12.9 | 26.5 | 27.0 | 26.5 | N/A | N/A | 17.1 |
| Total light transmittance | % | 92.0 | 91.8 | 91.5 | 91.5 | 91.3 | 91.8 | 92.9 | 91.9 | 92.0 | 91.54 | N/A | N/A | 88.9 |
| Storage stability | — | Good | Good | Good | Good | Good | Good | Good | Good | Good | Significant | Transfer | Transfer | Good |
| | | | | | | | | | | | scratches | failure | failure | |
| Handleability | — | Good | Good | Good | Good | Good | Good | Good | Good | Good | Significant | Good | Good | Good |
| | | | | | | | | | | | scratches | | | |
| Surface resistivity (×10¹¹) | Ω/□ | 4.6 | 0.85 | 3.2 | 6.8 | 10 | 6.5 | — | — | — | — | — | — | — |

(Table 4, Note)
*¹ through *⁵ are as in Table 2, Note.
*⁷ is as in Table 3, Note.
*⁸ Average particle size = 1.5 μm

As can be seen from Table 4, each of the transfer media of Examples 20 through 25 made by using the respective resin compositions of the present invention is easy to handle in its uncured state, has high formability, and can be used to make a laminate-transferred article having high hard coat property high dimming property and antistatic property.

The results of Examples 26 through 28 in Table 4 indicate that each of the resin compositions of the present invention not only ensures high storage stability of the transfer membrane, but also enables easy production of dimming hard coat transfer media with high haze value, high total light transmittance and high hard coat property, as well as of laminates using such transfer media. In comparison, the transfer membrane of Comparative Example 10, which meets the requirements (A) and (C) but not the requirement (B), is defective in its storage stability and handleability. The transfer media of Comparative Examples 11 and 12 meet the requirement (A) and (B), but not the requirement (C): Neither of them can be transferred properly and have essential performances required of a transfer membrane. The transfer membrane of Comparative Example 13 has a very low glass transition temperature and does not meet any of the requirements (A) through (C).

This indicates that the transfer membrane has low pencil hardness, low haze value and poor total light transmittance as compared to each of the transfer media of Examples 20 through 28.

### Examples 29 Through 34 and Comparative Examples 14 and 15

### Preparation of Resin Composition, Transfer Membrane and Laminate-Transferred Article

Using a gravure coating technique, a solution containing 3 parts by mass of silica fine powder (average particle size 100 nm), 3 parts by mass of methyltriethoxysilane, 0.2 parts by mass of acetic acid, 54 parts by mass of isopropyl alcohol and 40 parts by mass of ethanol was applied to a 38 μm-thick biaxially stretched polyethylene terephthalate film that has been release-treated. The coating was dried to form a 0.09 m-thick layer having a low refractive index. Using a bar coater, a solution having the following composition was applied over the low index layer 2.75 parts by mass of titanium oxide fine powder (average particle size=20 nm), 1.25 parts by mass of epoxy-modified bisphenol A diacrylate, 0.75 parts by mass of triazine triacrylate, 0.25 parts by mass of a photopolymerization initiator (trade name: Irgacure 184, available from Ciba specialty chemicals), 30 parts by mass of ethanol, 15 parts by mass of isopropanol, 15 parts by mass of butanol and 35 parts by mass of methyl ethyl ketone. The coating was dried at 140° C. for 30 sec and was irradiated with UV rays from an 80 W high-pressure mercury lamp (available from Ushio). The irradiation was done twice at a conveyor speed of 1 m/min with the distance between the light source and the coating kept at 10 cm. This cured the coating to form a high refractive index layer.

The resin compositions shown in Table 5 were prepared and each composition was applied over the high index layer to a film thickness of 5 μm. The coating was dried at 80° C. for 30 sec to form an adhesive layer. This completed a transfer membrane.

The transfer membrane was thermally transferred to a 2 mm-thick PMMA plate (plate temperature=80° C., roll speed=1 m/min, roll temperature=160° C.) and the polyethylene terephthalate film was peeled, leaving the transfer layer on the PMMA plate. The transfer layer on the PMMA plate was then irradiated twice with UV7 rays from an 80 W high-pressure mercury lamp (available from Ushio, conveyor speed=1 m/min, distance between the light source and the coating=10 cm) to cure. This completed a laminate-transferred article. The results of the measurement and evaluation of the resin compositions and the laminate-transferred articles obtained in Examples and Comparative Examples are collectively shown in Table 5.

TABLE 5

| | | Example | | | | | | Comparative Example | |
|---|---|---|---|---|---|---|---|---|---|
| | | 29 | 30 | 31 | 32 | 33 | 34 | 14 | 15 |
| P-1 | Wt pts | 20 | 0 | 0 | 0 | 0 | 0 | 0 | 0 |
| P-2 | Wt pts | 0 | 20 | 0 | 0 | 0 | 0 | 0 | 0 |
| P-3 | Wt pts | 0 | 0 | 20 | 0 | 0 | 0 | 0 | 0 |
| P-4 | Wt pts | 0 | 0 | 0 | 20 | 0 | 0 | 0 | 0 |
| P-5 | Wt pts | 0 | 0 | 0 | 0 | 20 | 0 | 0 | 0 |
| P-6 | Wt pts | 0 | 0 | 0 | 0 | 0 | 20 | 0 | 0 |
| P-7 | Wt pts | 0 | 0 | 0 | 0 | 0 | 0 | 20 | 0 |
| Photoacid generator *¹ | Wt pts | 1 | 1 | 1 | 1 | 1 | 1 | 1 | 0 |
| DPCA-60 *⁹ | Wt pts | 0 | 0 | 0 | 0 | 0 | 0 | 0 | 6 |
| Biscoat #540 *¹⁰ | Wt pts | 0 | 0 | 0 | 0 | 0 | 0 | 0 | 14 |
| Photopolymerization initiator *⁵ | Wt pts | 0 | 0 | 0 | 0 | 0 | 0 | 0 | 1 |
| Methyl isobutyl ketone | Wt pts | 30 | 30 | 30 | 30 | 30 | 30 | 30 | 0 |
| Methyl ethyl ketone | Wt pts | 49 | 49 | 49 | 49 | 49 | 49 | 49 | 79 |
| Tg | ° C. | 22.8 | 30.0 | 64.6 | 26.1 | 37.0 | 28.3 | 9.0 | −30≧ |
| Tackiness | — | 1 | 1 | 1 | 1 | 1 | 1 | 3 | 4 |
| Refractive index | — | 1.486 | 1.487 | 1.493 | 1.488 | 1.541 | 1.488 | 1.481 | 1.530 |
| Requirement (A) | — | G | G | G | G | G | G | G | NG |
| Requirement (B) | — | G | G | G | G | G | G | NG | NG |
| Requirement (C) | — | G | G | G | G | NG | G | G | NG |
| Adhesion (×100) | — | 100 | 100 | 100 | 100 | 100 | 100 | 100 | 100 |
| Pencil hardness | — | 5H | 4H | 4H | 4H | 4H | 4H | 5H | 3H |
| Minimum reflectance | — | 0.5 | 0.5 | 0.5 | 0.5 | 0.3 | 0.5 | 0.5 | 0.5 |
| Handleability | — | Good | Good | Good | Good | Good | Good | Significant | *¹¹ |
| | | | | | | | | scratches | |
| Oil film-like interference pattern | — | G | G | G | G | NG | G | G | NG |

(Table 5, Note)
*¹, *⁵ are as in Table 2, Note.
*⁹ dipentaerythritol hexaacrylate (DPCA-60, available from Nippon kayaku)
*¹⁰ ethyleneoxide-modified bisphenol A diacrylate (Biscoat #540, available from Osaka organic chemical)
*¹¹ Cannot be handled since the transfer layer remained adhered to the back or the transfer layer.

As can be seen from Table 5, each of the laminate-transferred articles of Examples 29 through 32 and 34, in which the transfer membrane meets all of the requirements (A), E) and (E), shows good results in any of the evaluated properties The laminate-transferred article of Example 33, with its transfer membrane meeting the requirements (A) and (E), shows good results comparable to the laminate-transferred articles of Examples 29 through 32 and 34 in adhesion, pencil hardness, minimum reflectance and handleability. However, the transfer membrane used in the laminate-transferred article of Example 33 does not meet the requirement (E). As a result, the article has a higher refractive Index than the articles of other Examples and causes interference patterns as seen in oil films. Conversely, Comparative Example 14 does not meet the requirement (B) and has a low glass transition temperature, a low tackiness and a low refractive index. As a result, the laminate received significant scratches. Not meeting any of the requirements (A), (B) and (E), Comparative Example 15 results in a significantly low glass transition temperature, a significantly reduced tackiness and too high a refractive index. As a result, the pencil hardness was reduced and the transfer layer remained adhered to the back of the transfer membrane. In addition, the handleab luty was significantly reduced and the interference patterns as seen in oil films were observed in Comparative Example 15. These results indicate that the requirement (E) must be met in order to prevent the oil film-like interference patterns.

### Example 35

### Preparation of Resin Composition and Production of Printed Articles by the Printing Method

Methyl isobutyl ketone (36 g), γ-methacryloyloxyropyltrimethoxysilane (trade name: KBM-503, available from Shin-etsu chemical) (16.8 g) and methylmethacrylate (available from Kuraray Co., Ltd.) (7.2 g) were placed in a 100 ml three-necked flask. The air in the flask was replaced by nitrogen.

Azobisisobutylonitrile (40 mg) was added and the mixture was stirred at 80° for 6 hours to form a polymerization solution. To 5 g of the resulting polymerization solution, a photoacid generator (200 mg (trade name: UVI-6992, available from Dow chemical Japan) and methyl ethyl ketone (4.8 g) were added to make an active energy ray-curable resin composition. The resin composition had a glass transition temperature of 22.8° C. (solid content).

Using a bar coater, the active energy ray-curable resin composition was applied to a PET film (trade name: Lumilar S10, thickness=38 μm, available from Toray industries) to a thickness (solid content) of 3 μm. The coating was dried at 80° C. for 30 sec to form an active energy ray-curable resin layer. This completed a laminate (Film A).

Using a bar coater, a resin composition to make a color layer was applied to a release-treated PET film (trade name: Cosmoshine, thickness=50 μm, available from Toyobo). The resin composition was composed of carbon black (4.5 g) (trade name: DENTALL BK-400M, available from Otsuska chemicals, polymethylmethacrylate (0.5 g) (trade name: PARAPET HR-L, available from Kuraray Co., Ltd.) and methyl ethyl ketone (5 g). The coating was dried at 80° for 30 sec to obtain a transfer membrane made of peelable PET/color layers (Film B).

Film A was irradiated with UV rays (at a dose of 2 mJ, HTE-30003, available from Hi-tech) on the side opposite to the active energy ray-curable resin layer. T was shone through a slit exposure mask. The slits in the mask were each 100 μm wide and were spaced apart by 100 μm. Using a laminator (line pressure=2.6 kgf/cm), Film B was laminated to Film A over the active energy ray-curable resin layer. Film B was then peeled to make a pattern-printed article. The printed article was irradiated with LTV rays on the active energy ray-curable resin layer. The resulting pattern-printed article had an accurate flawless printed pattern corresponding to the exposure mask (width=100 μm, space=100 μm). The printed pattern had no significant defects or peeling, demonstrating high printability of the method.

### Example 36

### Preparation of Transfer Membrane and Lenticular Lens Sheet

Using a bar coater, the active energy ray-curable resin composition used in Example 35 was applied to a release-treated PET film (trade name: Cosmoshine, thickness=50 μm, available from Toyobo) to a film thickness (solid content) of 3 μm. The coating was dried at 80° C. for 30 sec to make a transfer membrane made of peelable PET/exposure layers (Film C).

A lenticular lens sheet was obtained that has multiple convex cylindrical lenses formed on one surface at a pitch of 100 μm) and that is flat on the other surface. Film C was thermally transferred to the flat surface of the lenticular lens sheet (plate temperature=80° C., roll speed=1 m/min, roll temperature=160° C.) so as to transfer the layer of the active energy ray-curable resin composition (i.e., active energy ray-curable resin layer) to the lenticular lens sheet. The release-treated PET film was peeled to make a laminate having the lenticular lens sheet to serve as the substrate and the active energy ray-curable resin layer deposited on the substrate.

The laminate was irradiated with UV rays (at a dose of 2 mJ, HTE-3000B, available from Hi-tech) on the lenticular lens surface, so that the active energy ray-curable resin composition was cured only in the area on which the lenticular lens focuses light (irradiated area).

Using a laminator (line pressure=2.6 kgf/cm), Film B obtained in Example 35 was laminated to the laminate over the active energy ray-curable resin layer in which the active energy ray-curable resin composition was partially cured. Film B was then peeled to obtain a lenticular lens sheet having a light-blocking pattern.

The sheet was irradiated with UV on the active energy ray-curable resin layer. The resulting lenticular lens sheet having the light-blocking layer had an accurate light-blocking pattern corresponding to the pattern of the lenticular lens substrate (width=100 μm, space=50 μm). The pattern had no significant defects or peeling, demonstrating high printability of the method.

### Example 37

### Preparation of Transfer Membrane

Using a bar coater, a resin composition for patterning is applied to a release-treated PET film (trade name: Cosmoshine, thickness=50 μm, Toyobo) to a film thickness (solid content) of 3 μm. The resin composition was composed of silica fine particles (trade name: MEK-ST, available from Nissan chemical industries) (4.0 g by solid content), a pigment (0.5 g) (phthalocyanine copper), polymethylmethacrylate (0.5 g) (trade name: PARAPET HR-L, available from Kuraray Co., Ltd.) and methyl ethyl ketone (5 g) The coating was dried at 80° C. for 30 sec to make a transfer membrane made of peelable PET/color layers (Film 2-D).

### Comparative Example 16

### Preparation of Transfer Membrane

Polymethylmethacrylate 124 g) (trade name: PARAPET HR-T, available from Kuraray Co. Ltd.) was dissolved in methyl isobutyl ketone (36 g) to form a polymethylmethacrylate solution. The same process was carried out as in Example 35 except that the polymerization solution used in Example 35 was replaced by the polymethylmethacrylate solution.

Film A used in Example 35 was irradiated with UV rays (at a dose of 2 ml, HTE-3000E, available from Hi-tech) on the side opposite to the exposure layer. UV rays were shone through a slit exposure mask. The slits in the mask were each 100 μm wide and were spaced apart by 100 μm. Using a laminator (line pressure=2.6 kgf/cm), Film D was laminated to Film A over the exposure layer. Film D was then peeled to make a pattern-printed article. The resulting pattern-printed article had an accurate flawless printed pattern corresponding to the exposure mask (width=100 μm, space=100 μm). The printed pattern had no significant defects or peeling, demonstrating high printability of the method.

In contrast, the color layer of Film B was not transferred during the preparation of the pattern-printed article of Comparative Example 16 resulting in a failure in forming the desired pattern.

### INDUSTRIAL APPLICABILITY

The active energy ray-curable resin composition of the present invention can cure quickly and is formable, can be formed into a sheet that can be wound on a roll, and can form hard cured products. The active energy ray-curable resin composition is thus suitable for use in the curable resin layer of formable laminates and in the curable transfer layer of transfer membranes. Therefore, the resin composition of the present invention can be advantageously used in various hard coated shaped articles including dressers bath tubs and other sanitary products and automobile headlights and automobile windows.

The transfer membrane of the present invention includes a transfer layer in which an antireflective layer is strongly adhered to an adhesive layer. Such a transfer membrane can be effectively produced. The laminate-transferred article of the present invention obtained by transferring the transfer layer to a desired article has antireflective properties and hard coat properties, is easily handled and does not cause interference patterns as seen in oil films. Such a laminate-transferred article can be advantageously used in screen protection panels and other optical elements, as well as in name plates.

The printing method of the present invention uses an active energy ray-curable resin composition that has little or no tackiness in its uncured state. Thus, the printing method facilitates the handleability of the laminates that have a film of the resin composition deposited on their surfaces. Such laminates are less susceptible to adhesion of dust particles. Accordingly, the printing method of the present invention can be advantageously used in precision printing used to make optical elements, such as lenticular lenses, and graphic films.

1. An active energy ray-curable resin composition that cures primarily by the condensation of alkoxysilyl groups and that meets the following requirements (A), (B) and (C):
(A) the active energy ray-curable resin composition comprising the following components (a) and (b):
a component (a): a vinyl polymer having alkoxysilyl groups in its side chain and
a component (b): a photoacid generator;
(B) in its uncured state, the active energy ray-curable resin composition has a glass transition temperature of 15° C. to 100° C.; and
(C) 90 mass/or more of Si-containing compound or Si-containing compound unit present in the active energy ray-curable resin composition is represented by the following structural formula 1:
(R¹)ₙSi(OR²)₄₋ₙ (Structural formula 1)
wherein R¹ is a structural unit of the backbone of the vinyl polymer of the component (a), a residue bound to the backbone, a polymerizable group that can see as the structural unit or the residue, or a substituted or unsubstituted alkyl or aryl group; R² is an alkyl group having 1 to 5 carbon atoms; and n is an integer of 1 to 3.

2. The active energy ray-curable resin composition according to claim 1, wherein the component (a) is an alkoxysilyl-containing (meth)acrylate polymer.

3. The active energy ray-curable resin composition according to claim 1, wherein the active energy ray-curable resin composition further comprises the following component (c):
a component (C): a surfactant comprising hydrocarbon groups having 8 to 30 carbon atoms.

4. The active energy ray-curable resin composition according to claim 1, wherein the active energy ray-curable resin composition meets the following requirement (D):
(D): the composition has an optically uniform refractive index in the visible range.

5. The active energy ray-curable resin composition according to claim 1, wherein the active energy ray-curable resin composition in a cured state meets the following requirement (E):
(E): the refractive index of the cured resin composition is in a range of 1.4 to 1.51.

6. A laminate comprising a substrate, and an active energy ray-curable resin layer formed of the active energy ray-curable resin composition according to claim 1 and laminated on the substrate.

7. The laminate according to claim 6, wherein the substrate is a postformable substrate so that the laminate is used as a postformable laminate.

8. The laminate according to claim 6, wherein the substrate is a base film that may include a release layer and the active energy ray-curable resin layer serves as a transfer layer so that the laminate is used as a transfer membrane.

9. The laminate according to claim 8, wherein the side surface of the base film facing the transfer layer has is uneven.

10. The laminate according to claim 8, wherein the transfer layer includes an antireflection layer so that the laminate is used as a transfer membrane.

11. A method for producing a cured laminate comprising a cured resin layer formed on a substrate, comprising irradiating the active energy ray-curable resin layer of the laminate according to claim 6 with an active energy ray to cure the active energy ray-curable resin layer to form a cured resin layer.

12. A method for producing a cured laminate shaped article from the laminate according to claim 7 that is used as a postformable laminate, the method comprising the following steps (1) and (2) of:
(1) shaping the laminate according to claim 7 that is used as a postformable laminate by heating it to a temperature at which the laminate can be shaped; and
(2) irradiating the active energy ray-curable resin layer of the shaped article obtained in the step (1) with an active energy ray to cure the active energy ray-curable resin layer to form a cured resin layer.

13. A method for producing a laminate-transferred article from the laminate according to claim 8 that is used as a transfer membrane, the method comprising the following steps (I) and (II) of:
(I) transferring the transfer layer of the laminate according to claim 8 that is used as a transfer membrane bringing the transfer layer into contact with an article and subsequently peeling the base film; and
(II) irradiating the transfer layer transferred to the article obtained in the step (I) with an active energy ray to cure the active energy ray-curable resin layer in the transfer layer to for a cured resin layer.

14. A printing method comprising the steps (i) through (iii) of:
(i) irradiating par of the active energy ray-curable resin layer of the laminate according to claim 6 with an active energy ray to cure the active energy ray-curable resin layer only in the part irradiated with the active energy ray to thereby for a cured area and an uncured area in the active energy ray-curable resin layer,
(ii) laminating and pressing a patterning resin layer onto the active energy ray-curable resin layer of the laminate obtained in the step (i), the patterning resin layer being formed of a patterning resin on position comprising 50 mass % to 95 mass % of an inorganic filler mixed with a binder; and
(iii) removing the patterning resin layer from the cured area of the active energy ray-curable resin layer of the laminate obtained in the step (ii), leaving the patterning resin layer only in the uncured area, to form a resin patter.

15. The printing method according to claim 14, wherein,
in the step (i), the substrate of the laminate is flat on one side and contains a plurality of aligned convex lenses on the other side the active energy ray-curable resin layer is laminated on the flat surface of the substrate to form the laminate and the laminate is irradiated from its convex lens surface side of the substrate with the active energy ray and in the step (ii), the pattering resin composition contains a colorant and the patterning resin layer forms a light-blocking pattern.

16. The printing method according to claim 14, further comprising, after the step (iii), the step (iv) of:
(iv) irradiating the entire surface of the active energy ray-curable resin layer with an active energy ray to cure the entire active energy ray-curable resin layer.

17. A cured laminate obtained by the production method according to claim 11.

18. The cured laminate according to claim 17, serving as a screen protection panel.

19. A printed article obtained by the printing method according to claim 14.

20. The printed article according to claim 19, used as a lenticular lens sheet obtained by the printing method according to claim 15, wherein the patterning resin composition comprises a colorant and the patterning resin layer forms a light-blocking pattern.
